(19) United States
(12) Patent Application Publication
(10) Pub. No.: US 2022/0148081 A1
(43) Pub. Date: May 12, 2022

(54) INFORMATION PROCESSING APPARATUS, INFORMATION PROCESSING METHOD, AND PROGRAM

(71) Applicant: NIPPON GAS CO., LTD., Tokyo (JP)

(72) Inventor: Shinji WADA, Tokyo (JP)

(21) Appl. No.: 17/599,382

(22) PCT Filed: Feb. 26, 2020
(86) PCT No.: PCT/JP2020/007678

§ 371 Date: Sep. 28, 2021

(30) Foreign Application Priority Data
Mar. 29, 2019 (JP) 2019-065430

(51) Int. Cl. G06Q 40/02; G06Q 50/06

(52) U.S. Cl. CPC G06Q 40/025; G06Q 50/06

(57) ABSTRACT

Conventionally, it is difficult to acquire a credit rating of a household. It is possible to acquire a credit rating of a household, using an information processing apparatus that includes: an acceptance unit that accepts a customer identifier that identifies a customer; a gas information acquisition unit that acquires gas information that contains gas use information regarding use of gas, and that is associated with the same customer identifier as the customer identifier accepted by the acceptance unit; a credit rating information acquisition unit that acquires credit rating information that specifies a credit rating of a household that is identified by the customer identifier accepted by the acceptance unit, using the gas information acquired by the gas information acquisition unit; and a credit rating information output unit that outputs the credit rating information acquired by the credit rating information acquisition unit.

### TECHNICAL FIELD

The present invention relates to, for example, an information processing apparatus that acquires and outputs credit rating information regarding the credit rating of one household, using information regarding the use of gas of the one household.

### BACKGROUND ART

There is a conventional determination apparatus that determines a credit rating of an individual (see Patent Document 1). Such a determination apparatus includes an acquisition unit and a determination unit. The acquisition unit acquires asset information that is information obtained by combining individual assets owned by a first user, in a given manner, and an action history of the first user on a network. The determination unit estimates information regarding the assets of the first user based on the asset information regarding the first user, acquired by the acquisition unit, and the action history on the network.

### CITATION LIST

### Patent Document

Patent Document 1: JP 2018-110017A

### SUMMARY OF INVENTION

### Technical Problem

However, with the conventional technology, it is difficult to acquire the credit rating of a household.

### Solution to Problem

An information processing apparatus according to a first aspect of the present invention is an information processing apparatus including: an acceptance unit that accepts a customer identifier that identifies a customer; a gas information acquisition unit that acquires gas information that contains gas use information regarding use of gas, and that is associated with the same customer identifier as the customer identifier accepted by the acceptance unit; a credit rating information acquisition unit that acquires credit rating information that specifies a credit rating of a household that is identified by the customer identifier accepted by the acceptance unit, using the gas information acquired by the gas information acquisition unit; and a credit rating information output unit that outputs the credit rating information acquired by the credit rating information acquisition unit.

With such a configuration, it is possible to acquire a credit rating of a household, using information regarding the use of gas.

An information processing apparatus according to a second aspect of the present invention is the information processing apparatus according to the first aspect of the invention, wherein the gas use information includes gas use fee category information that specifies how high a gas use fee is, and the gas information contains, in addition to the gas use fee category information, one or more pieces of information of: gas supply category information that specifies a type of gas that is supplied; gas payment category information that specifies a payment means for a gas fee; and housing category information that specifies a type of a residence of a customer.

With such a configuration, it is possible to acquire a credit rating of a household, using appropriate information regarding the use of gas.

An information processing apparatus according to a third aspect of the present invention is the information processing apparatus according to the first or second aspect of the invention, further including an electricity customer information acquisition unit that acquires electricity customer information regarding use of electricity, associated with the same customer identifier as the customer identifier accepted by the acceptance unit, wherein the credit rating information acquisition unit acquires credit rating information, using the electricity customer information as well.

With such a configuration, it is possible to acquire a credit rating of a household, using information regarding the use of electricity as well.

An information processing apparatus according to a fourth aspect of the present invention is the information processing apparatus according to the third aspect of the invention, wherein the electricity customer information contains one or more pieces of information of: electricity supply category information that specifies a type of electricity supplied; electricity payment category information that specifies a means for payment of an electricity fee; housing category information that specifies a type of a residence of a customer; and electricity use fee category information that specifies how high an electricity use fee is.

With such a configuration, it is possible to acquire a credit rating of a household, using appropriate information regarding the use of electricity as well.

An information processing apparatus according to a fifth aspect of the present invention is the information processing apparatus according to any one of the first to fourth aspects of the invention, further including a water service customer information acquisition unit that acquires water service customer information regarding use of water service, associated with the same customer identifier as the customer identifier accepted by the acceptance unit, wherein, the credit rating information acquisition unit acquires credit rating information, using the water service customer information as well.

With such a configuration, it is possible to acquire a credit rating of a household, using information regarding the use of water service as well.

An information processing apparatus according to a sixth aspect of the present invention is the information processing apparatus according to the fifth aspect of the invention, wherein the water service customer information contains one or more pieces of information of: water service supply category information that specifies a type of water service supplied; water service payment category information that specifies a means for payment of water service fee; housing category information that specifies a type of residence of a customer; and water service use fee category information that specifies how high a water service use fee is.

With such a configuration, it is possible to acquire a credit rating of a household, using appropriate information regarding the use of water service as well.

An information processing apparatus according to a seventh aspect of the present invention is the information processing apparatus according to any one of the first to sixth aspects of the invention, further including a bank customer information acquisition unit that acquires bank customer information regarding a bank account, associated with a personal identifier that is paired with the same customer identifier as the customer identifier accepted by the acceptance unit, wherein the credit rating information acquisition unit acquires credit rating information, using the bank customer information as well.

With such a configuration, it is possible to acquire a credit rating of a household, using information regarding a bank account as well.

An information processing apparatus according to an eighth aspect of the present invention is the information processing apparatus according to the seventh aspect of the invention, wherein the bank customer information acquisition unit acquires two or more pieces of bank customer information that are associated with two or more personal identifiers that are paired with the same customer identifier as the customer identifier accepted by the acceptance unit, and the credit rating information acquisition unit acquires credit rating information, using the two or more pieces of bank customer information as well.

With such a configuration, it is possible to acquire a credit rating of a household, using information regarding multiple family members related to a bank account as well.

An information processing apparatus according to a ninth aspect of the present invention is the information processing apparatus according to the seventh or eighth aspect of the invention, wherein the bank customer information contains one or more pieces of information of: an amount of bank account activity; a deposit balance; a housing category information that specifies a type of a residence of a customer; presence or absence of a credit card; and presence or absence of a safe deposit box.

With such a configuration, it is possible to acquire a credit rating of a household, using appropriate information regarding a bank account as well.

An information processing apparatus according to a tenth aspect of the present invention is the information processing apparatus according to any one of the first to ninth aspects of the invention, further including a mobile customer information acquisition unit that acquires mobile customer information regarding use of a mobile, associated with a personal identifier that is paired with the same customer identifier as the customer identifier accepted by the acceptance unit, and the credit rating information acquisition unit acquires credit rating information, using the mobile customer information as well.

With such a configuration, it is possible to acquire a credit rating of a household, using information regarding the use of a mobile as well.

An information processing apparatus according to an eleventh aspect of the present invention is the information processing apparatus according to the tenth aspect of the invention, wherein the mobile customer information acquisition unit acquires two or more pieces of mobile customer information that are associated with two or more personal identifiers that are paired with the same customer identifier as the customer identifier accepted by the acceptance unit, and the credit rating information acquisition unit acquires credit rating information, using the two or more pieces of mobile customer information as well.

With such a configuration, it is possible to acquire a credit rating of a household, using information regarding multiple family members in terms of the use of a mobile as well.

An information processing apparatus according to a twelfth aspect of the present invention is the information processing apparatus according to the tenth or eleventh aspect of the invention, wherein the mobile customer information contains one or more pieces of information of: a mobile bill payment history; and a mobile use status.

With such a configuration, it is possible to acquire a credit rating of a household, using appropriate information regarding the use of a mobile as well.

An information processing apparatus according to a thirteenth aspect of the present invention is the information processing apparatus according to any one of the first to twelfth aspects of the invention, further including: a gas information storage unit that stores two or more pieces of gas information that contain gas use information, in association with a customer identifier; a gas information reception unit that receives gas information that is associated with a cylinder identifier, from a gas information transmission apparatus that includes: a terminal acquisition unit that acquires gas information that is information that contains gas use information regarding use of gas in an LPG cylinder and corresponds to a cylinder identifier that specifies an LPG cylinder; and a terminal transmission unit that transmits the gas information acquired by the terminal acquisition unit to the information processing apparatus; and a gas information accumulation unit that accumulates the gas information received by the gas information reception unit, in the gas information storage unit, in association with time information and the cylinder identifier, wherein the gas information acquisition unit acquires gas information that contains gas use information that is contained in two or more pieces of gas information that are associated with the same customer identifier as the customer identifier accepted by the acceptance unit.

With such a configuration, it is easier to collect gas information regarding customers.

### Advantageous Effects of Invention

With the information processing apparatus according to the present invention, it is possible to acquire a credit rating of a household.

### BRIEF DESCRIPTION OF DRAWINGS

FIG. 1 is a conceptual diagram for an information system A according to Embodiment 1.

FIG. 2 is a block diagram for the information system A according to the same.

FIG. 3 is a block diagram for an information processing apparatus A2 according to the same.

FIG. 4 is a flowchart illustrating examples of operations that are performed by a gas information transmission apparatus A1 according to the same.

FIG. 5 is a flowchart illustrating examples of operations that are performed by an information processing apparatus A2 according to the same.

FIG. 6 is a flowchart illustrating examples of operations that are performed by a next deliverer terminal A3 according to the same.

FIG. 7 is a flowchart illustrating examples of operations that are performed by a facility terminal A4 according to the same.

FIG. 8 is a conceptual diagram for the information system A according to the same.

FIG. 9 is a conceptual diagram for an information system G according to Embodiment 2.

FIG. 10 is a block diagram for the information system C according to the same.

FIG. 11 is a flowchart illustrating an example of household credit rating acquisition processing that is performed by an information processing apparatus G2 according to the same.

FIG. 12 is a flowchart illustrating an example of gas score acquisition processing according to the same.

FIG. 13 is a flowchart illustrating an example of electricity charge score acquisition processing according to the same.

FIG. 14 is a flowchart illustrating an example of water service charge score acquisition processing according to the same.

FIG. 15 is a flowchart illustrating an example of bank score acquisition processing according to the same.

FIG. 16 is a flowchart illustrating an example of mobile score acquisition processing according to the same.

FIG. 17 is a conceptual diagram showing a concept of processing that is performed by the information system G according to the same.

FIG. 18 is an overview diagram for a computer system according to the above embodiments.

FIG. 19 is a block diagram for the computer system according to the same.

### DESCRIPTION OF EMBODIMENTS

### Embodiment 2

### Description of Embodiments

The following describes embodiments of information system and so on with reference to the drawings. Note that the components with the same reference numerals in the embodiments perform the same operations, and therefore redundant descriptions thereof may be omitted.

### Embodiment 1

The present embodiment describes an information system that includes one or more gas information transmission apparatuses that acquire and transmit gas information that includes information regarding the use of gas in one or more LPG cylinders, and information processing apparatus.

In addition, the present embodiment describes an information system that includes a gas information transmission apparatus that transmits two or more pieces of gas information all at once. Note that the gas information transmission apparatus acquires gas use information described later, once an hour, and transmits the gas use information for one day, to the information processing apparatus, once a day, for example. Note that the gas information transmission apparatus may acquires the gas use information described later once an hour, and separately transmits the gas use information for one day, to the information processing apparatus, twice a day or more, for example.

Furthermore, the present embodiment describes an information system that includes an information processing apparatus that also receives delivery cylinder information described later, delivery vehicle position information described later, climate information described later, and cylinder replacement information described later.

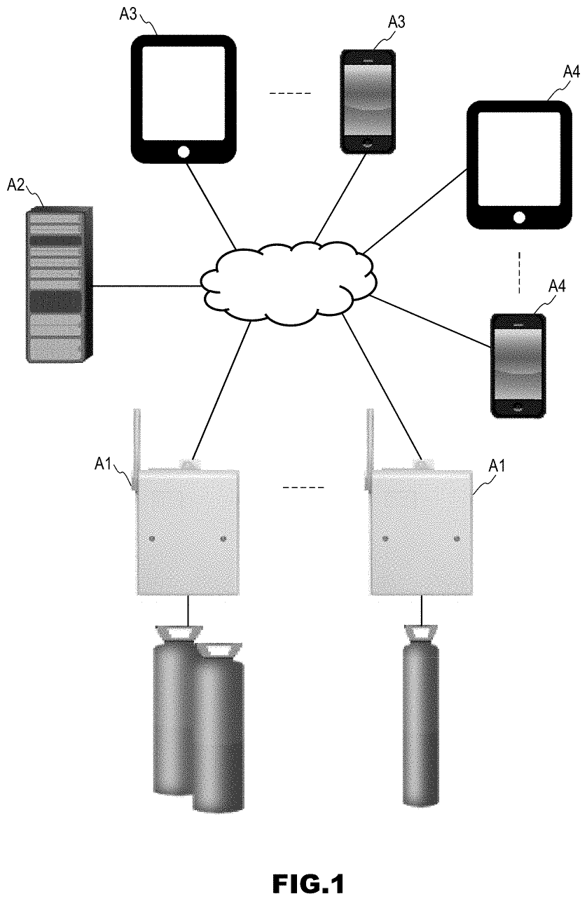

FIG. 1 is a conceptual diagram for an information system A according to the present embodiment. The information system A includes one or more gas information transmission apparatuses A1, an information processing apparatus A2, one or more deliverer terminals A3, and one or more facility terminals A4.

Gas information transmission apparatuses A1 are apparatuses that acquire gas information that includes gas use information, and transmit the gas information to the information processing apparatus A2. The gas information transmission apparatus A1 need only have a communication function, and the type thereof is not limited.

The information processing apparatus A2 is a server apparatus that receives and accumulates information such as gas information. “Information such as gas information” may be gas information alone, or one or more pieces of information of: delivery cylinder information described later; delivery vehicle position information described later; cylinder replacement information described later; and climate information may be used in addition to gas information. The information processing apparatus A2 can be realized using a so-called cloud server or an ASP server, but there is no limitation on the type thereof.

The deliverer terminals A3 are terminals that are used by deliverers. However, the deliverer terminals A3 may be terminals that are mounted on delivery vehicles. The deliverer terminals A3 are, for example, smartphones, tablet terminals, so-called personal computers, or the like, but there is no limitation on the type thereof. The deliverer terminals A3 have a communication function.

The facility terminals A4 are terminals that are present in the facility. The facility terminals A4 are, for example, smartphones, tablet terminals, so-called personal computers, or the like, but there is no limitation on the type thereof. The facility terminals A4 have a communication function. The facility is, for example, a factory or a depot station. A factory is a facility for filling gas cylinders with gas. A depot station is a facility where gas cylinders are placed.

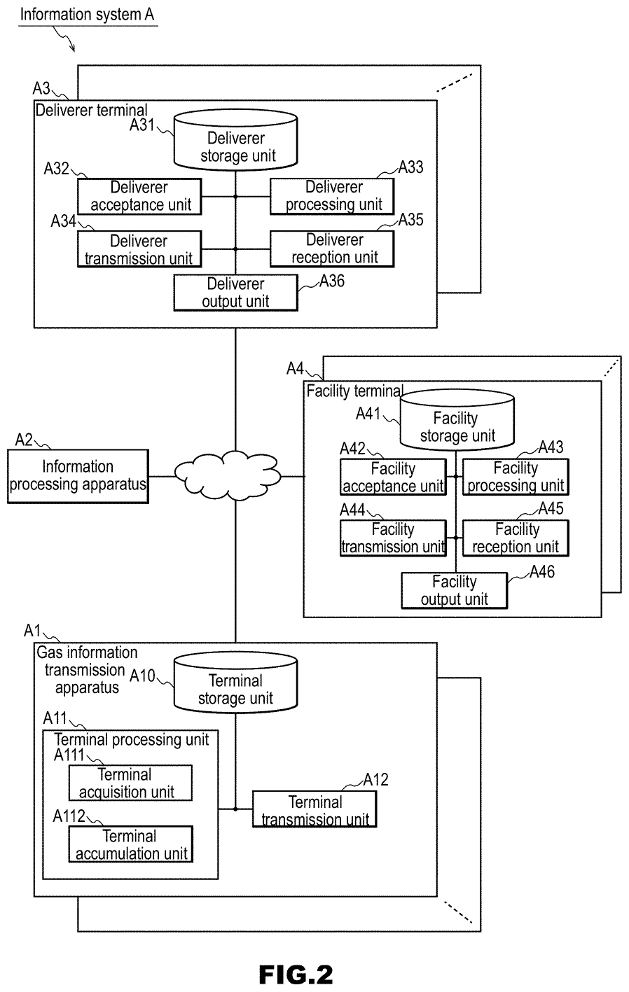

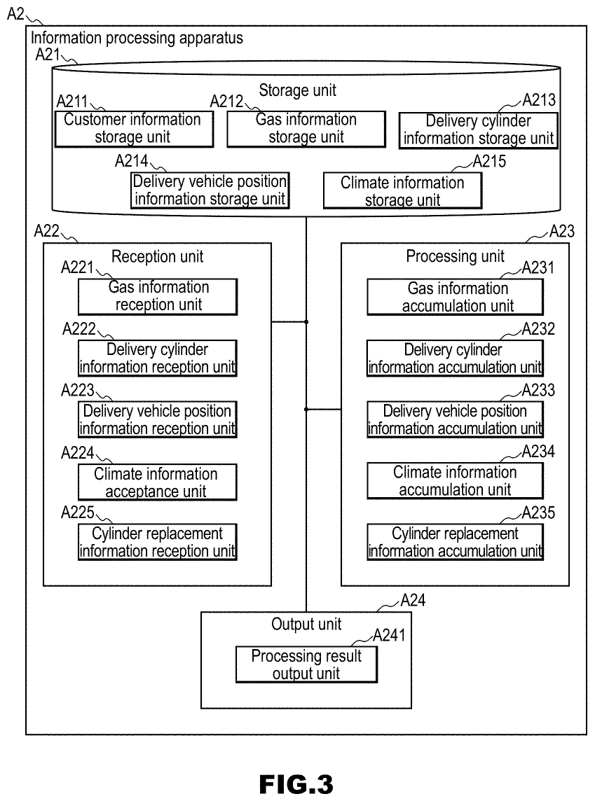

FIG. 2 is a block diagram for the information system A according to the present embodiment. FIG. 3 is a block diagram for the information processing apparatus A2 that is included in the information system A.

The gas information transmission apparatuses A1 includes a terminal storage unit A10, a terminal processing unit A11, and a terminal transmission unit A12. The terminal processing unit A11 includes a terminal acquisition unit A111 and a terminal accumulation unit A112.

The information processing apparatus A2 includes a storage unit A21, a reception unit A22, a processing unit A23, and an output unit A24. The storage unit A21 includes a customer information storage unit A211, a gas information storage unit A212, a delivery cylinder information storage unit A213, a delivery vehicle position information storage unit A214, and a climate information storage unit A215. The reception unit A22 includes a gas information reception unit A221, a delivery cylinder information reception unit A222, a delivery vehicle position information reception unit A223, a climate information acceptance unit A224, and a cylinder replacement information reception unit A225. The processing unit A23 includes a gas information accumulation unit A231, a delivery cylinder information accumulation unit A232, a delivery vehicle position information accumulation unit A233, a climate information accumulation unit A234, and a cylinder replacement information accumulation unit A235. The output unit A24 includes a processing result output unit A241.

Each deliverer terminal A3 includes a deliverer storage unit A31, a deliverer acceptance unit A32, a deliverer processing unit A33, a deliverer transmission unit A34, a deliverer reception unit A35, and a deliverer output unit A36.

Each facility terminal A4 includes a facility storage unit A41, a facility acceptance unit A42, a facility processing unit A43, a facility transmission unit A44, a facility reception unit A45, and a facility output unit A46.

The terminal storage unit A10 included in each gas information transmission apparatus A1 stores various kinds of information. Examples of the various kinds of information include gas information, a customer identifier that identifies a customer, a cylinder identifier that identifies a cylinder, and time information that specifies a time. Time information is, for example, date information that specifies a date, time point information that specifies a date and time, and time zone information that specifies a time zone. When time information is time point information, the time information may be regarded as including date information.

The terminal storage unit A10 stores pieces of gas information as of two or more points in time. Gas information is, for example, information associated with a cylinder identifier, a customer identifier that identifies a customer, and date information that indicates a date. Gas information is associated with time information, for example. Gas information contains, for example, gas use information. Gas use information is information regarding the gas used. Gas information contains, for example, one or more pieces of information of: unit time gas use information; and gas meter reading value information. Unit time gas use information is information that specifies the amount of gas used per unit time. Unit time gas use information is, for example, information that specifies the amount of gas used every one hour. Gas meter reading value information is, for example, information that specifies a gas meter reading value. Gas meter reading value information is, for example, information that specifies gas meter reading values acquired every one hour.

The gas information in the terminal storage unit A10 typically is information accumulated by the terminal accumulation unit A112.

The terminal processing unit A11 performs various kinds of processing. Examples of the various kinds of processing include processing that is performed by the terminal acquisition unit A111 and the terminal accumulation unit A112. Examples of the various kinds of processing include processing that is performed to delete gas information that has been transmitted, from the terminal storage unit A10.

The terminal acquisition unit A111 acquires gas information that is information that includes gas use information regarding the use of gas in an LPG cylinder and corresponds to a cylinder identifier that identifies an LPG cylinder. The terminal acquisition unit A111 acquires, for example, information from a gas meter. The terminal acquisition unit A111 acquires, for example, a meter reading value acquired from a gas meter, and calculates a gas use information that is the difference between the previous meter reading value and the current meter reading value and specifies the amount of gas used per unit time.

It is preferable that the terminal acquisition unit A111 acquires gas use information n times a day (n is 2 or more) every unit time. It is also preferable that the terminal acquisition unit A111 acquires gas use information every one hour.

It is preferable that the terminal acquisition unit A111 acquires time information from a clock (not shown) and associates the time information with the acquired gas use information. Note that the clock (not shown) may be present in the gas information transmission apparatuses A1 or may be a clock of an external apparatus such as an NTP server.

The terminal accumulation unit A112 accumulates the gas information acquired by the terminal acquisition unit A111, in the terminal storage unit A10. It is preferable that the terminal accumulation unit A112 accumulates the gas information acquired by the terminal acquisition unit A111, in the terminal storage unit A10 every unit time. Note that the unit time is, for example, on hour, thirty minutes, two hours, or the like. It is also preferable that the terminal accumulation unit A112 accumulates the gas information acquired by the terminal acquisition unit A111, in the terminal storage unit A10 in association with one or more pieces of information of: a customer identifier, a cylinder identifier, and time information.

The terminal transmission unit A12 transmits the gas information acquired by the terminal acquisition unit A111 to the information processing apparatus A2. The gas information acquired by the terminal acquisition unit A111 may be the gas information stored in the terminal storage unit A10.

The terminal transmission unit A12 transmits, for example, the gas information acquired by the terminal acquisition unit A111 to the information processing apparatus A2 in association with one or more identifiers. The one or more identifiers are, for example, one or more identifiers of: a cylinder identifier; and a cylinder identifier.

It is preferable that the terminal transmission unit A12 transmits gas information as of two or more time points stored in the terminal storage unit A10 to the information processing apparatus A2 when a predetermined condition is satisfied. The predetermined condition is, for example, that a predetermined time is reached, a predetermined number of pieces of gas information are stored in the terminal storage unit A10, or the like. In addition, transmitting gas information in association with a cylinder identifier or the like is, for example, transmitting gas information together with a cylinder identifier or the like, but there is no limitation on the method of associating pieces of information with each other. Note that the cylinder identifier is normally stored in the terminal storage unit A10. It is also preferable that, when the cylinder to be used is changed to another cylinder, the cylinder identifier of the other cylinder is automatically stored in the terminal storage unit A10.

Here, the transmission of gas information as of two or more time points may mean the transmission of two or more information sets that each consists of a piece of gas information and a piece of time information, or the transmission of two or more pieces of gas information arranged in chronological order.

In addition, the transmission of gas information for one day may mean the transmission of twenty-four information sets that each consists of gas information and time information, or the transmission of twenty-four pieces of gas information arranged in chronological.

Note that one piece of gas information is information that contains one piece of gas use information, but one piece of gas information may be information that contains a plurality of pieces of gas use information.

It is preferable that the terminal transmission unit A12 transmits two or more pieces of gas information in the terminal storage unit A10 to the information processing apparatus A2 less than n times a day.

It is preferable that the terminal transmission unit A12 transmits gas information to the information processing apparatus A2 once a day. Note that there is no limitation on the time at which the terminal transmission unit A12 transmits gas information.

The terminal transmission unit A12 may transmit gas information at different time points depending on a condition. That is, for example, the terminal transmission unit A12 may normally transmit a plurality of pieces of gas information to the information processing apparatus A2 at a low frequency (a first frequency), and when a predetermined condition is satisfied, the terminal transmission unit A12 may transmit gas information to the information processing apparatus A2 at a higher frequency (a second frequency) than the frequency in the normal case. The predetermined condition here is, for example, that the terminal processing unit A11 determines that the amount of gas that has been used is large enough to satisfy the predetermined condition (for example, an amount of gas no less than or greater than a threshold value has been used). Alternatively, the predetermined condition is, for example, that the terminal processing unit A11 determines that a small amount of gas has been used for a period that is long enough to satisfy the predetermined condition (for example, an amount of gas no greater than or less than a threshold value has been used for a period no less than a first threshold value).

It is also preferable that, after the terminal transmission unit A12 has transmitted gas information to the information processing apparatus A2, the terminal processing unit A11 deletes the transmitted gas information from the terminal storage unit A10.

The storage unit A21 included in the information processing apparatus A2 stores various kinds of information. Examples of the various kinds of information include customer information described later, gas information, delivery cylinder information described later, delivery vehicle position information described later, and climate information described later.

The customer information storage unit A211 stores one or more pieces of customer information each in association with a customer identifier. Customer information is information regarding a customer. Customer information contains, for example, a name, customer position information, and contact information. Customer position information is information that specifies the position of a customer. Customer position information is, for example, (latitude,longitude), address, or the like. Contact information is information that specifies a point of contact, and is, for example, an e-mail address or a telephone number. date information contains, for example, date information that specifies the date on which the gas cylinder was replaced. The customer information contains, for example, cylinder type information, cylinder number information, and gas remaining amount information. Cylinder type information is information that specifies the type of the cylinder used by the customer. The cylinder number information is information that specifies the number of cylinders installed in the customer's home. Gas remaining amount information is information that specifies the amount of gas remaining in the customer's gas cylinders. Customer information contains, for example, one or more medium identifiers that identify the medium used by the customer (for example, “LPG” and “electricity”), one or more appliance identifiers of energy appliances owned by the customer (for example, “gas appliance A”, “electric appliance B”, and “appliance C”), and one or more company identifiers that identify the energy companies with which the customer has a contract (for example, “company A”). Customer information may contain, for example, LPG cylinder information that contains cylinder capacity information regarding the capacity of the LPG cylinder used by the customer. Note that LPG cylinder information may be cylinder type information.

The gas information storage unit A212 stores one or more pieces of gas information. The gas information storage unit A212 normally stores two or more pieces of gas information associated with customer identifiers. It is preferable that the pieces of gas information are associated with one or more pieces of information of: time information that specifies a time; and a cylinder identifier. In addition, here, the association with time information and cylinder identifier may be realized by storing gas information so that time information and a cylinder identifier can be known.

The delivery cylinder information storage unit A213 stores one or more pieces of delivery cylinder information. Delivery cylinder information is information regarding a cylinder that is to be delivered. Delivery cylinder information contains, for example, cylinder type information and cylinder state information. Delivery cylinder information typically is information from which the number of cylinders can be known. That is to say, delivery cylinder information may contain number information that specifies the number of cylinders, or the number of pieces of delivery cylinder information that have been received may indicate the number of cylinders. Cylinder type information is information that specifies the type of the cylinder, and indicates, for example, 20 Kg, 30 Kg, or 50 Kg. Cylinder state information is information that indicates whether or not the cylinder is full. Delivery cylinder information corresponds to, for example, one or more pieces of information of: a cylinder identifier; a delivery vehicle identifier; a deliverer identifier; and time information that specifies entry/exit date and time. Note that the entry/exit date and time is an entry date and time or an exit date and time to/from a factory where the cylinder is to be filled with gas, or entry date and time or an exit date and time to/from a depot station where cylinders are stored. Alternatively, time point information may be information that only specifies a date.

The delivery vehicle position information storage unit A214 stores one or more pieces of delivery vehicle position information. Delivery vehicle position information is information that specifies the position of a delivery vehicle. Delivery vehicle position information is, for example, (latitude,longitude), but may be, for example, a facility identifier that identifies the nearest facility. The facility is, for example, a factory or a depot station. Delivery vehicle position information is associated with, for example, a delivery vehicle identifier that identifies the delivery vehicle for the cylinder, or a deliverer identifier.

The climate information storage unit A215 stores one or more pieces of climate information. Climate information is information regarding weather. Climate information is, for example, one or more pieces of information of: weather; temperature; humidity; and so on. It is preferable that climate information is associated with time information. Time information is, for example, date information and time point information.

The reception unit A22 receives various kinds of information. Examples of the various kinds of information include gas information, delivery cylinder information, delivery vehicle position information, climate information, and cylinder replacement information.

The gas information reception unit A221 receives one or more pieces of gas information from the gas information transmission apparatuses A1. The gas information reception unit A221 receives, for example, gas information associated with one or more identifiers of: a customer identifier; and a cylinder identifier, from the gas information transmission apparatuses A1.

The delivery cylinder information reception unit A222 receives one or more pieces of delivery cylinder information. The delivery cylinder information reception unit A222 receives delivery cylinder information in association with one or more pieces of information of: a cylinder identifier; a delivery vehicle identifier; and a deliverer identifier, for example. The delivery cylinder information reception unit A222 receives delivery cylinder information in association with a loading platform identifier, for example. The loading platform identifier is information that specifies a loading platform loading platform on which the cylinder is placed. The delivery cylinder information reception unit A222 receives delivery cylinder information in association with time point information that identifies entry/exit date and time, for example. The entry/exit date and time is the date and time of entry/exit to/from a facility. The delivery cylinder information reception unit A222 receive delivery cylinder information from the facility terminals A4, for example. The delivery cylinder information reception unit A222 receive delivery cylinder information from the deliverer terminals A3, for example. Note that there is no limitation on the source of delivery cylinder information. The cylinder identifier is, for example, information stored in a communication means (for example, an RFID tag) installed in a cylinder that is to be delivered, and indirectly or directly received from such a communication means. The cylinder identifier may be, for example, information input to a facility terminal A4 by a user and transmitted from the facility terminal A4. The delivery vehicle identifier is, for example, information stored in a communication means (for example, an RFID tag) installed in a delivery vehicle itself (for example, a trailer head), and indirectly or directly received from such a communication means. Note that, in such a case, the delivery vehicle identifier may be referred to as a trailer head identifier. In addition, the delivery vehicle identifier and the trailer head identifier may be different pieces of information, and in such a case, the delivery cylinder information reception unit A222 may receive delivery cylinder information in association with the trailer head identifier. In addition, the deliverer identifier is, for example, information indirectly or directly received from a deliverer terminal A3 held by a deliverer. The deliverer identifier may be, for example, information stored in a communication means installed in a delivery vehicle itself (for example, a trailer head), and indirectly or directly received from such a communication means. Furthermore, the loading platform identifier is, for example, information stored in a communication means (for example, an RFID tag) installed in a loading platform of a delivery vehicle, and indirectly or directly received from such a communication means.

The delivery vehicle position information reception unit A223 receives one or more pieces of delivery vehicle position information. The delivery vehicle position information reception unit A223 normally receives delivery vehicle position information from the deliverer terminals A3 that are terminals on delivery vehicles, but there is no limitation on the source of delivery vehicle position information. Note that the deliverer terminals A3 may be terminals that are different from the terminals held by deliverers, and may be terminals mounted on delivery vehicles.

The delivery vehicle position information reception unit A223 normally receives delivery vehicle position information in association with a delivery vehicle identifier that identifies a delivery vehicle. However, the delivery vehicle position information reception unit A223 may receive delivery vehicle position information in association with a deliverer identifier. Also, delivery vehicle identifier and deliverer identifier may be the same information.

The climate information acceptance unit A224 receives one or more pieces of climate information. Here, “acceptance” means, for example, reception from a server apparatus (not shown), but may be regarded as a concept that includes acceptance of information input from an input device such as a keyboard, a mouse, or a touch panel, or acceptance of information read from a recording medium such as an optical disk, a magnetic disk, or a semiconductor memory. Note that the server apparatus (not shown) is an apparatus that stores climate information.

The cylinder replacement information reception unit A225 receives one or more pieces of cylinder replacement information. Cylinder replacement information is information that indicates that a cylinder has been replaced. The cylinder replacement information reception unit A225 receives cylinder replacement information that is paired with one or more pieces of information of: a customer identifier; and a cylinder identifier, for example. The cylinder replacement information reception unit A225 receives, for example, cylinder replacement information from a deliverer terminal A. Note that there is no limitation on the transmission source of cylinder replacement information.

The processing unit A23 performs predetermined processing, using two or more pieces of gas information stored in the gas information storage unit A212. Examples of the predetermined processing include delivery date prediction processing described later, delivery control processing described later, futures trading processing described later, residence stay processing described later, energy optimum plan presentation processing described later, household credit rating acquisition processing described later, statistical processing, and so on. statistical processing is statistical processing to be performed on a plurality of pieces of gas information. Examples of statistical processing includes processing that is performed to calculate the average amount of gas used by a household for a certain period from a plurality of pieces of gas information, processing that is performed to calculate the cumulative value of the amount of gas used for a certain period, and processing that is performed to acquire a graph showing changes in the amount of gas used. Note that delivery date prediction processing, delivery control processing, futures trading processing, residence stay processing, energy optimum plan presentation processing, and household credit rating acquisition processing will be described in Embodiment 2 and the subsequent embodiments. Note that delivery date prediction processing is processing that is performed to predict the delivery date on which a gas cylinder is to be delivered to household. Delivery control processing is processing that is performed to deliver a gas cylinder to a household that has run out of gas, for example. Futures trading processing is processing that is performed to determine the price of gas and supporting futures trading. Residence stay processing is processing that is performed to output information regarding whether or not an inhabitant is present in a residence. Energy optimum plan presentation processing is processing that is performed to present an appropriate energy plan. Household credit rating acquisition processing is processing that is performed to acquire and output a credit rating of a household.

The processing unit A23 performs predetermined processing, also using one or more pieces of delivery cylinder information stored in the delivery cylinder information storage unit A213, for example. The predetermined processing is, for example, delivery control processing.

The processing unit A23 performs the predetermined processing, using one or more pieces of delivery vehicle position information stored in the delivery vehicle position information storage unit A214, for example. The predetermined processing is, for example, delivery control processing.

The processing unit A23 performs the predetermined processing, using one or more pieces of climate information stored in the climate information storage unit A215. Examples of the predetermined processing include delivery date prediction processing, futures trading processing, and energy optimum plan presentation processing.

The gas information accumulation unit A231 accumulates the one or more pieces of gas information received by the gas information reception unit A221, in the gas information storage unit A212. The gas information accumulation unit A231 accumulates each piece of gas information received by the gas information reception unit A221, in the gas information storage unit A212, in association with one or more pieces of information of: time information; a customer identifier; and a cylinder identifier. Note that such time information may be information received from the gas information transmission apparatuses A1, or information acquired from a clock (not shown).

The delivery cylinder information accumulation unit A232 accumulates the one or more pieces of delivery cylinder information received by the delivery cylinder information reception unit A222, in the delivery cylinder information storage unit A213. The delivery cylinder information accumulation unit A232 accumulates each piece of delivery cylinder information in the delivery cylinder information storage unit A213 in association with one or more pieces of information of: a cylinder identifier; a delivery vehicle identifier; and a deliverer identifier, for example.

The delivery vehicle position information accumulation unit A233 accumulates the one or more pieces of delivery vehicle position information received by the delivery vehicle position information reception unit A223, in the delivery vehicle position information storage unit A214. The delivery vehicle position information accumulation unit A233 accumulates each piece of delivery vehicle position information in the delivery vehicle position information storage unit A214 in association with a delivery vehicle identifier or a deliverer identifier.

The climate information accumulation unit A234 accumulates one or more pieces of climate information, in the climate information storage unit A215. The climate information accumulation unit A234 normally each piece of climate information in the climate information storage unit A215 in association with time information. Note that time information may be information received by the reception unit A22 or may be acquired from a clock (not shown). In addition, time information may be date information or time point information.

When the cylinder replacement information reception unit A225 receives cylinder replacement information, the cylinder replacement information accumulation unit A235 updates the gas remaining amount information contained in the gas information paired with one or more pieces of information of: a customer identifier; and a cylinder identifier, to information that specifies that the amount of gas remaining is full.

The deliverer storage unit A31 included in each deliverer terminal A3 stores various kinds of information. Examples of the various kinds of information include a deliverer identifier that identifies a deliverer. Examples of the various kinds of information include a delivery vehicle identifier that identifies a delivery vehicle. The deliverer identifier and the delivery vehicle identifier may be the same information. Examples of the various kinds of information include cylinder replacement information. Cylinder replacement information is information that indicates that a cylinder has been replaced. Cylinder replacement information is associated with one or more identifiers of: a customer identifier; and a cylinder identifier.

The deliverer acceptance unit A32 accepts various instructions and various kinds of information. Examples of the various instructions and various kinds of information include cylinder replacement information. Examples of the various instructions and various kinds of information include cylinder replacement information and one or more identifiers of: a customer identifier; and a cylinder identifier. When a cylinder of a certain household is to be replaced or has been replaced, the deliverer inputs cylinder exchange information to the deliverer terminal A3. In addition, cylinder replacement information may be input by pressing a button, or may be input by inputting information in a field, for example.

It is preferable that the deliverer inputs one or more identifiers of: a customer identifier; and a cylinder identifier together with cylinder replacement information. In such a case, the deliverer acceptance unit A32 accepts cylinder replacement information, and one or more identifiers of: a customer identifier; and a cylinder identifier.

Any input means may be employed to input cylinder replacement information, such as a touch panel, a keyboard, a mouse, a menu screen, or the like. The deliverer acceptance unit A32 can be realized using a device driver for the input means such as a touch panel or a keyboard, or control software or the like for controlling the menu screen.

The deliverer processing unit A33 performs various kinds of processing. Examples of the various kinds of information include processing that is performed to convert the information accepted by the deliverer acceptance unit A32 so as to have a data structure of information to be transmitted. Examples of the various kinds of processing include processing that is performed when the deliverer acceptance unit A32 accepts cylinder replacement information, to form information in which the cylinder replacement information, the deliverer identifier in the deliverer storage unit A31, and one or more identifiers of: the customer identifier; and the cylinder identifier, which have been input, are associated with each other. Examples of the various kinds of information include processing that is performed to convert the information received by the deliverer reception unit A35 so as to have a data structure of information that is to be output.

The deliverer transmission unit A34 transmits cylinder replacement information to the information processing apparatus A2. The deliverer transmission unit A34 normally transmits cylinder replacement information that is associated with one or more identifiers of: a customer identifier; and a cylinder identifier, to the information processing apparatus A2. It is preferable that the deliverer transmission unit A34 transmits a deliverer identifier as well as cylinder replacement information.

The deliverer reception unit A35 receives various kinds of information. The deliverer reception unit A35 receives various kinds of information from the information processing apparatus A2, for example. The deliverer reception unit A35 receives customer information described later, from the information processing apparatus A2, for example. Note that customer information is information regarding a customer, and is information paired with a customer identifier. The customer information received by the deliverer reception unit A35 is information regarding the customer to which a gas cylinder is to be delivered, for example. Note that the customer identifier may be contained in customer information.

The deliverer output unit A36 outputs various kinds of information. Examples of the various kinds of information include information formed by the deliverer processing unit A33. Examples of the various kinds of information include customer information. Customer information is information regarding the customer to which a gas cylinder is to be delivered. It is preferable that customer information contains one or more pieces of information of: a customer identifier; customer position information; and information regarding the gas cylinder to be delivered. Customer position information is information that specifies the position of a customer. Customer position information is, for example, (latitude,longitude), address, or the like. Information regarding the gas cylinder to be delivered is, for example, cylinder type information that specifies the type of a gas cylinder, the number of gas cylinders, and so on.

Here, “output” typically means displaying on a display device, but may be regarded as a concept that includes projection with a projector, printing with a printer, sound output, transmission to an external apparatus, accumulation on a recording medium, delivery of processing results to another processing apparatus or another program, and so on.

The facility storage unit A41 included in each facility terminal A4 stores various kinds of information. Examples of the various kinds of information include a facility identifier that identifies a facility. It is preferable that the facility storage unit A41 stores delivery cylinder information that is information received by a terminal in a delivery vehicle, (for example, an RFID) and is information regarding a cylinder mounted on the delivery vehicle. Delivery cylinder information is associated with a cylinder identifier. It is preferable that delivery cylinder information is associated with a loading platform identifier and entry/exit date and time, for example. Delivery cylinder information contains, for example, cylinder type information and cylinder state information. It is preferable that delivery cylinder information contains information that specifies the number of cylinders to be delivered.

The facility acceptance unit A42 accepts various instructions and various kinds of information.

The facility processing unit A43 performs various kinds of processing. Examples of the various kinds of processing include processing that is performed to accumulate information received by the facility reception unit A45. The facility processing unit A43 at least temporarily accumulates the delivery cylinder information and identifiers received by the facility reception unit A45, in the facility storage unit A41. Note that examples of the identifiers include one or more identifiers of: a cylinder identifier; a loading platform identifier; a delivery vehicle identifier; and a deliverer identifier.

The facility transmission unit A44 transmits various kinds of information. The facility transmission unit A44 transmits, for example, various kinds of information to the information processing apparatus A2. The facility transmission unit A44 transmits delivery cylinder information in association with identifiers, for example. Examples of the identifiers include one or more identifiers of: a cylinder identifier; a loading platform identifier; a delivery vehicle identifier; and a deliverer identifier.

The facility reception unit A45 receives various kinds of information. The facility reception unit A45 receives, for example, various kinds of information from a terminal of a delivery vehicle (for example, an RFID). The facility reception unit A45 receives delivery cylinder information in association with identifiers, for example. Examples of the identifiers include one or more identifiers of: a cylinder identifier; a loading platform identifier; a delivery vehicle identifier; and a deliverer identifier.

The facility output unit A46 outputs various kinds of information.

It is preferable that the terminal storage unit A10, the storage unit A21, the customer information storage unit A211, the gas information storage unit A212, the delivery cylinder information storage unit A213, the delivery vehicle position information storage unit A214, the climate information storage unit A215, the deliverer storage unit A31, and the facility storage unit A41 are realized using a non-volatile recording medium, but they can be realized using a volatile recording medium.

There is no limitation on the process in which information is stored in the terminal storage unit A10 and so on. For example, information may be stored in the terminal storage unit A10 or the like via a recording medium, or information transmitted via a communication line or the like may be stored in the terminal storage unit A10 or the like, or information input via an input device may be stored in the terminal storage unit A10 or the like.

The terminal processing unit A11, the terminal acquisition unit A111, the terminal accumulation unit A112, the processing unit A23, the gas information accumulation unit A231, the delivery cylinder information accumulation unit A232, the delivery vehicle position information accumulation unit A233, the climate information accumulation unit A234, the cylinder replacement information accumulation unit A235, the deliverer processing unit A33, and the facility processing unit A43 can typically be realized using an MPU, a memory, or the like. The processing procedures performed by the terminal processing unit A11 and so on typically are realized using software, and the software is recorded on a recording medium such as a ROM. However, such processing procedures may be realized using hardware (a dedicated circuit). Needless to say, a CPU or a GPU may be used instead of the MPU.

The terminal transmission unit A12, the output unit A24, processing result output unit A241, the deliverer transmission unit A34, and the facility transmission unit A44 typically are realized using a wireless or wired communication means, but may be realized using a broadcast means.

The reception unit A22, the gas information reception unit A221, the delivery cylinder information reception unit A222, the delivery vehicle position information reception unit A223, the climate information acceptance unit A224, the cylinder replacement information reception unit A225, the deliverer reception unit A35, and the facility reception unit A45 typically are realized using a wireless or wired communication means, but may be realized using a means for receiving broadcast.

The deliverer acceptance unit A32 and the facility acceptance unit A42 can be realized using a touch panel, a keyboard, a mouse, a menu screen, or the like.

The deliverer output unit A36 and the facility output unit A46 may be regarded as including or not including an output device such as a display or a speaker. The deliverer output unit A36 and so on can be realized using the driver software of the output device, the driver software of the output device and the output device, or the like.

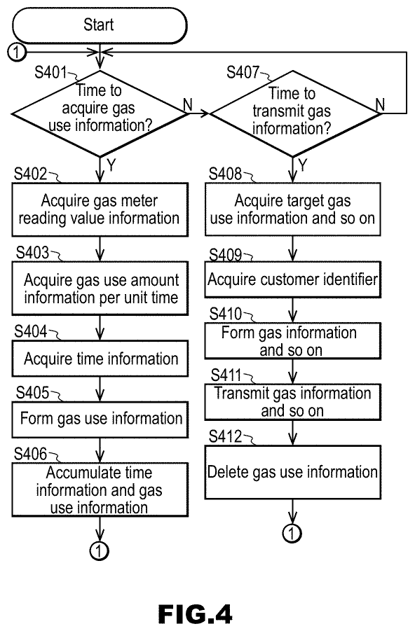

Next, operations that are performed by the information system A will be described. First, examples of operations that are performed by the gas information transmission apparatus A1 will be described with reference to the flowchart shown in FIG. 4.

(Step S401) The terminal processing unit A11 determines whether or not it is the time to acquire gas use information. If it is the time to acquire gas use information, processing proceeds to step S402, and if it is not the time to acquire gas use information, processing proceeds to step S407. For example, when acquiring gas use information every one hour, the terminal processing unit A11 acquires time information from a clock (not shown), and if the time indicated by the time information matches “X hour 00 minutes” (X is a natural number in the range of 1 to 24), the terminal processing unit A11 determines that it is the time to acquire gas use information.

(Step S402) The terminal acquisition unit A111 acquires gas meter reading value information from a gas meter (not shown). Noted that such a technique is a well-known technique. Note that the gas meter typically is an LP gas meter, and is a device that holds the gas meter reading value that indicates the flow rate integration measured from the installation of the device.

(Step S403) The terminal acquisition unit A111 calculates information indicating gas use amount per unit time, which is the difference between the previously acquired gas meter reading value information and the gas meter reading value information currently acquired in step S402. Note that the terminal acquisition unit A111 acquires the information indicating the gas use amount per unit time by calculating, for example, “information indicating the gas use amount per unit time=the previously acquired gas meter reading value information−the gas meter reading value information acquired in step S402”.

(Step S404) The terminal acquisition unit A111 acquires time information that indicates the current time from a clock (not shown).

(Step S405) The terminal acquisition unit A111 forms gas use information to be accumulated, using the information indicating the gas use amount per unit time, acquired in step S403.

(Step S406) The terminal accumulation unit A112 accumulates the time information acquired in step S404 and the gas use information formed in step S405 in association with each other. Processing returns to step S401. Note that the location where the gas use information or the like is to be accumulated typically is the terminal storage unit A10. Note that the terminal accumulation unit A112 may accumulate gas use information in association with a cylinder identifier. In such a case, the terminal acquisition unit A111 acquires the cylinder identifier as well.

(Step S407) The terminal processing unit A11 determines whether or not it is the time to transmit gas information. If it is the time to transmit gas information, processing proceeds to step S408, and if it is not the time to transmit gas information, processing returns to step S401. For example, when transmitting gas information once a day, the terminal processing unit A11 acquires time information from a clock (not shown), and upon determining that the time indicated by the time information has passed a predetermined time (for example, “24:01”), the terminal processing unit A11 determines that it is the time to transmit gas information. Note that even if it is determined that the predetermined time has passed, the gas information that has already been transmitted is usually not transmitted again. Also, even if the terminal processing unit A11 determines that the predetermined time has passed, the terminal processing unit A11 usually does not determine that it is the time to transmit gas information until a predetermined period (for example, one day) elapses.

(Step S408) The terminal processing unit A11 acquires gas use information and so on to be transmitted, from the terminal storage unit A10. The gas use information and so on are, for example, a set of pieces of information composed of gas use information and time information, gas use information alone, gas use information and a cylinder identifier, or a set of pieces of information composed of gas use information, a cylinder identifier, and time information.

(Step S409) The terminal processing unit A11 acquires a customer identifier from the terminal storage unit A10.

(Step S410) The terminal processing unit A11 forms gas information and so on to be transmitted. Gas information contains, for example, a plurality of pieces of gas use information and so on and one or more identifiers. The one or more identifiers are, for example, one or more pieces of information of: a customer identifier; and a cylinder identifier.

(Step S411) The terminal transmission unit A12 transmits the gas information and so on formed in step S410 to the information processing apparatus A2.

(Step S412) The terminal processing unit A11 deletes the transmitted gas use information and so on. Here, a flag indicating that the information has been transmitted may be accumulated in association with the transmitted gas use information and so on. Such addition of a flag may be regarded as the same as the deletion. Processing returns to step S401.

In the flowchart shown in FIG. 4, the number of times gas use information is accumulated is larger than the number of times gas information is transmitted. That is to say, in the flowchart shown in FIG. 4, a plurality of pieces of gas use information are transmitted to the information processing apparatus A2 all at once. As a result, the power consumption of the gas information transmission apparatus A1 can be reduced, and the frequency of battery replacement of the gas information transmission apparatus A1 can be reduced. However, in the flowchart shown in FIG. 4, gas information may be transmitted each time gas use information is acquired.

Also, in the flowchart shown in FIG. 4, the terminal transmission unit A12 may transmit gas information to the information processing apparatus A2 at different frequencies in a case where a predetermined condition is satisfied and in a case where the predetermined condition is not satisfied. Here, the predetermined condition is, for example, that the terminal processing unit A11 determines that the amount of gas that has been used is large enough to satisfy the predetermined condition.

In the flowchart shown in FIG. 4, processing is terminated when power is turned off or an interruption is made to terminate the processing.

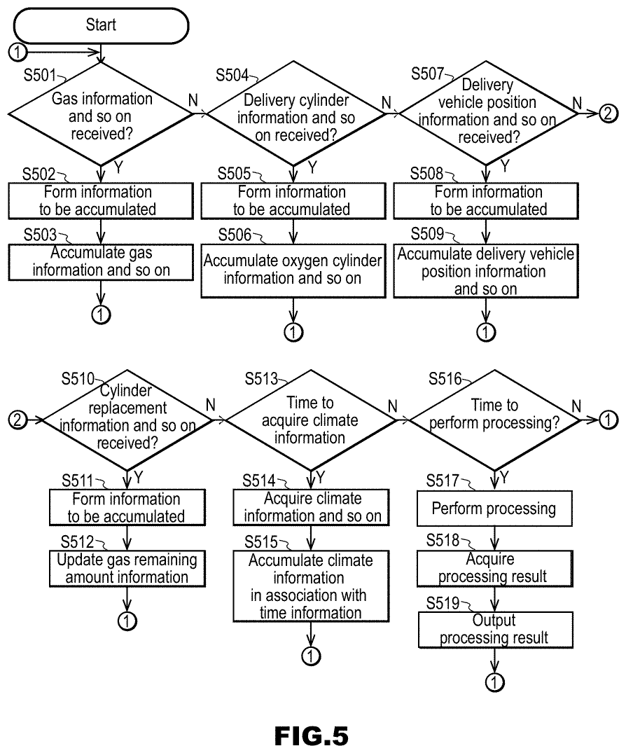

Next, examples of operations that are performed by the information processing apparatus A2 will be described with reference to the flowchart shown in FIG. 5.

(Step S501) The gas information reception unit A221 determines whether or not gas information and so on transmitted from the gas information transmission apparatuses A1 have been received. If gas information and so on have been received, processing proceeds to step S502, and if gas information and so on have not been received, processing proceeds to step S504. Gas information and so on are, for example, gas information and one or more identifiers. The one or more identifiers are, for example, one or more pieces of information of: a customer identifier; and a cylinder identifier.

(Step S502) The gas information accumulation unit A231 forms gas information and so on to be accumulated, using the gas information and so on received in step S501.

(Step S503) The gas information accumulation unit A231 accumulates the gas information and so on formed in step S502 in the gas information storage unit A212. Processing returns to step S501.

(Step S504) The delivery cylinder information reception unit A222 determines whether or not delivery cylinder information and so on have been received. If delivery cylinder information and so on have been received, processing proceeds to step S505, and if delivery cylinder information and so on have not been received, processing proceeds to step S507. Delivery cylinder information and so on are, for example, delivery cylinder information and one or more identifiers. The one or more identifiers are, for example, one or more pieces of information of: a cylinder identifier; a deliverer identifier; and a delivery vehicle identifier.

(Step S505) The delivery cylinder information accumulation unit A232 forms delivery cylinder information and so on to be accumulated, using the delivery cylinder information and so on received in step S504.

(Step S506) The delivery cylinder information accumulation unit A232 accumulates the delivery cylinder information and so on formed in step S505, in the delivery cylinder information storage unit A213. Processing returns to step S501.

(Step S507) The delivery vehicle position information reception unit A223 determines whether or not delivery vehicle position information and so on have been received. If delivery vehicle position information and so on have been received, processing proceeds to step S508, and if delivery vehicle position information and so on have not been received, processing proceeds to step S510. Delivery vehicle position information and so on are, for example, delivery vehicle position information and one or more identifiers. The one or more identifiers are, for example, one or more pieces of information of: a deliverer identifier; and a delivery vehicle identifier.

(Step S508) The delivery vehicle position information accumulation unit A233 forms delivery vehicle position information and so on to be accumulated, using the delivery vehicle position information and so on received in step S507.

(Step S509) The delivery vehicle position information accumulation unit A233 accumulates the delivery vehicle position information and so on formed in step S508, in the delivery vehicle position information storage unit A214. Processing returns to step S501.

(Step S510) Cylinder replacement information reception unit A225 determines whether or not cylinder replacement information and so on have been received. If cylinder replacement information and so on have been received, processing proceeds to step S511, and if cylinder replacement information and so on have not been received, processing proceeds to step S513. Cylinder replacement information and so on are, for example, cylinder replacement information and one or more identifiers. The one or more identifiers are, for example, one or more pieces of information of: a customer identifier; and a cylinder identifier.

(Step S511) The cylinder replacement information accumulation unit A235 forms cylinder replacement information and so on to be accumulated, using the cylinder replacement information and so on received in step S510.

(Step S512) The cylinder replacement information accumulation unit A235 updates the gas remaining amount information regarding the customer information storage unit A211, using the cylinder replacement information and so on formed in step S511. Processing returns to step S501.

(Step S513) The processing unit A23 determines whether or not it is the time to acquire climate information. If it is the time to acquire climate information, processing proceeds to step S514, and if it is not the time to acquire climate information, processing proceeds to step S516. Note that the time to acquire climate information is, for example, every one hour, every one day, or the like.

(Step S514) The climate information acceptance unit A224 acquires climate information and so on from a server (not shown). Here, the climate information acceptance unit A224 may acquire climate information and so on regarding two or more regions, for example.

(Step S515) The climate information accumulation unit A234 accumulates the climate information and so on acquired in step S514 in association with time information, in the climate information storage unit A215. Processing returns to step S501. Climate information and so on are, for example, climate information and time information. The climate information accumulation unit A234 may accumulate climate information and so on in association with time information and a region identifier that identifies a region, in the climate information storage unit A215.

(Step S516) The processing unit A23 determines whether or not it is the time to perform processing, using gas information. If it is the time to perform processing, processing proceeds to step S517, and if it is not the time to perform processing, processing returns to step S501.

(Step S517) The processing unit A23 preforms predetermined processing. Examples of predetermined processing include delivery date prediction processing, delivery control processing, futures trading processing, residence stay processing, energy optimum plan presentation processing, household credit rating acquisition processing, and statistical processing.

(Step S518) The processing unit A23 acquires a processing result that is information that specifies the result of processing performed in step S517.

(Step S519) The processing result output unit A241 outputs the processing result acquired in step S518. Processing returns to step S501.

In the flowchart shown in FIG. 5, processing is terminated when power is turned off or an interruption is made to terminate the processing.

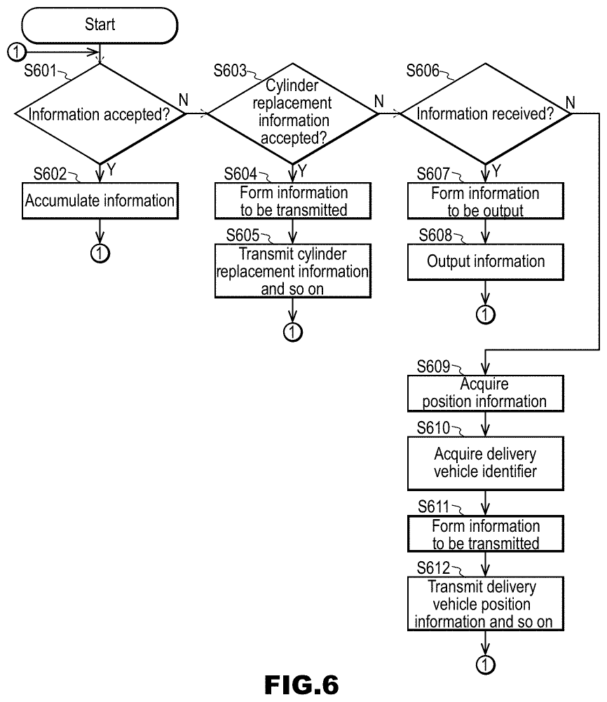

Next, examples of operations that are performed by each deliverer terminal A3 will be described with reference to the flowchart shown in FIG. 6.

(Step S601) The deliverer acceptance unit A32 determines whether or not information has been accepted. If information has been accepted, processing proceeds to step S602, and if information has not been accepted, processing proceeds to step S603. Examples of information include a customer identifier and a cylinder identifier.

(Step S602) The deliverer processing unit A33 at least temporarily accumulate the information accepted in step S601, in the deliverer storage unit A31. Processing returns to step S601.

(Step S603) The deliverer acceptance unit A32 determines whether or not cylinder replacement information has been accepted. If cylinder replacement information has been accepted, processing proceeds to step S604, and if cylinder replacement information has not been accepted, processing proceeds to step S606.

(Step S604) The deliverer processing unit A33 forms cylinder replacement information and so on to be transmitted. Cylinder replacement information and so on contain, for example, a customer identifier and a cylinder identifier.

(Step S605) The deliverer transmission unit A34 transmits the cylinder replacement information and so on formed in step S604 to the information processing apparatus A2. Processing returns to step S601.

(Step S606) The deliverer reception unit A35 determines whether or not information has been received. If information has been received, processing proceeds to step S607, and if information has not been received, processing proceeds to step S609. Note that examples of information include customer information and a delivery list. The delivery list is information regarding a list of customers to which the deliverer delivers gas cylinders.

(Step S607) The deliverer processing unit A33 forms information that is to be output, using the information received in step S606. Examples of information that is to be output include customer information, a delivery list, a map that explicitly shows the position specified by the customer position information contained in the customer information, and route information that is the result of a search for a route from the position specified by delivery vehicle position information to the position specified by the customer position information. Note that the deliverer processing unit A33 may have the function of acquiring delivery vehicle position information (for example, the function of a GPS receiver) and a route search function.

(Step S608) The deliverer output unit A36 outputs the information formed in step S607. Processing returns to step S601.

(Step S609) The deliverer processing unit A33 acquires position information regarding the delivery vehicle. Note that when the deliverer processing unit A33 acquires position information, the deliverer processing unit A33 typically has a GPS receiver, but may use another means to acquire position information. The other means uses, for example, the strength of radio waves transmitted from three or more radio base stations, to perform processing, for example.

(Step S610) The deliverer processing unit A33 acquires a delivery vehicle identifier from the deliverer storage unit A31.

(Step S611) The deliverer processing unit A33 forms delivery vehicle position information and so on to be transmitted, using the delivery vehicle position information acquired in step S609 and the delivery vehicle identifier acquired in step S610.

(Step S612) The deliverer transmission unit A34 transmits the delivery vehicle position information and so on formed in step S611 to the information processing apparatus A2. Processing returns to step S601.

Note that there is no limitation on the time at which the delivery vehicle position information is transmitted in the flowchart shown in FIG. 6.

In the flowchart shown in FIG. 6, processing is terminated when power is turned off or an interruption is made to terminate the processing.

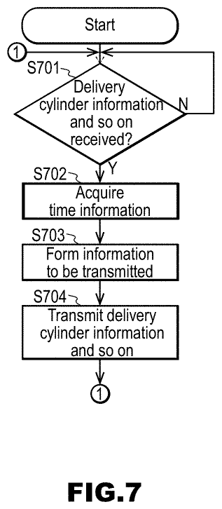

Next, examples of operations that are performed by each facility terminal A4 will be described with reference to the flowchart shown in FIG. 7.

(Step S701) The facility reception unit A45 determines whether or not delivery cylinder information and so on have been received. If delivery cylinder information and so on have been received, processing proceeds to step S702, and if delivery cylinder information and so on have not been received, processing returns to step S701.

(Step S702) The facility processing unit A43 acquires time information from a clock (not shown).

(Step S703) The facility processing unit A43 forms delivery cylinder information and so on to be transmitted, using the delivery cylinder information and so on received in step S701 and the time information acquired in step S702.

(Step S704) The facility transmission unit A44 transmits the delivery cylinder information and so on formed in step S703 to the information processing apparatus A2. Processing returns to step S701.

In the flowchart shown in FIG. 7, processing is terminated when power is turned off or an interruption is made to terminate the processing.

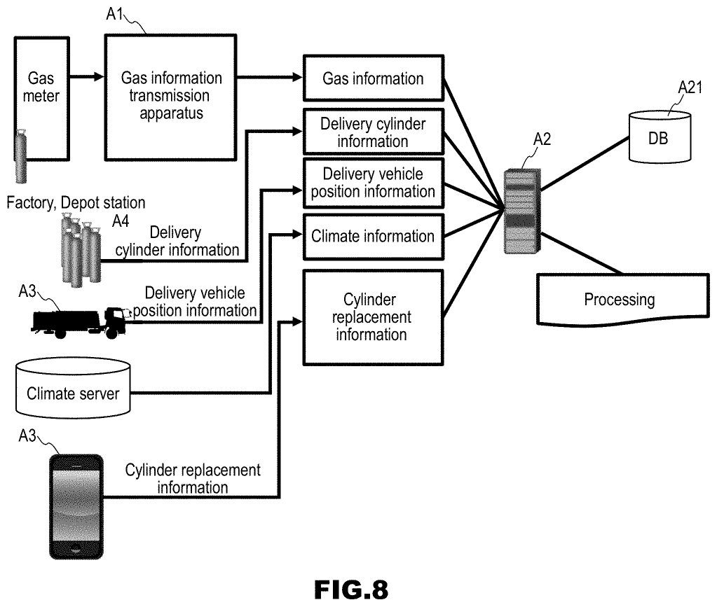

The following describes specific examples of operations that are performed by the information system A according to the present embodiment with reference to a conceptual diagram (FIG. 8) for processing that is performed by the information system A. Note that the conceptual diagram for the system structure of the information system A is FIG. 1.

In the information system A, as described above, pieces of gas information are transmitted from the gas information transmission apparatuses A1 to the information processing apparatus A2 at appropriate points in time, and are accumulated in the information processing apparatus A2. Also, pieces of delivery vehicle position information are transmitted from the deliverer terminals A3 to the information processing apparatus A2, and are accumulated in the information processing apparatus A2. Also, pieces of delivery cylinder information are transmitted from the facility terminals A4 to the information processing apparatus A2, and are accumulated in the information processing apparatus A2. Also, pieces of cylinder replacement information are transmitted from the deliverer terminals A3 to the information processing apparatus A2, and are accumulated in the information processing apparatus A2. Also, the information processing apparatus A2 receives and accumulates climate information from a climate server (not shown). Note that the climate server is a server that stores climate information.

The deliverer terminals A3 that transmit delivery vehicle position information and the deliverer terminals A3 that transmit the deliverer terminals A3 are terminals used by deliverers, and, needless to say, they may be different terminals.

In the information processing apparatus A2, the processing unit A23 performs various kinds of processing, using various kinds of information accumulated in the DB (A21). Examples of the various kinds of processing include delivery date prediction processing, delivery control processing, futures trading processing, residence stay processing, energy optimum plan presentation processing, and household credit rating acquisition processing. Examples of the various kinds of processing may also include processing performed to simply output the results of the above-described statistical processing and various kinds of accumulated information.

As described above, according to the present embodiment, the gas information and so on that contain gas use information regarding the use of LPG cylinders can be collected and used.

In addition, according to the present embodiment, the power consumption of the power source of the gas information transmission apparatuses A1 can be reduced by efficiently transmitting gas information.

In addition, according to the present embodiment, delivery cylinder information that is information regarding the cylinders to be delivered can also be collected and used.

In addition, according to the present embodiment, delivery cylinder information that is information that contains cylinder type information can also be collected and used.

In addition, according to the present embodiment, climate information can also be acquired and used.

Furthermore, according to the present embodiment, cylinder replacement information can be received and used when a cylinder is replaced.

Note that the processing in the present embodiment may be realized using software. This software may be distributed through software downloading or the like. Also, this software may be recorded on a recording medium such as a CD-ROM and distributed. Note that the same applies to the other embodiments in the present description. The software that realizes the gas information transmission apparatuses A1 in the present embodiment is the program described below. That is to say, this program is a program that enables a computer that can access a terminal storage unit that stores pieces of gas information as of two or more points in time to function as: a terminal acquisition unit that acquires gas information that is information that includes gas use information regarding use of gas in an LPG cylinder and corresponds to a cylinder identifier that identifies an LPG cylinder; a terminal accumulation unit that accumulates the gas information acquired by the terminal acquisition unit, in the terminal storage unit; a terminal transmission unit that, when a predetermined condition is satisfied, transmits the pieces gas information as of the two or more pints in time stored in the terminal storage unit to the information processing apparatus in association with a customer identifier.

The software that realizes the information processing apparatus A2 in the present embodiment is the program described below. That is to say, this program is a program that enables a computer that can access a gas storage unit that stores two or more pieces of gas information in association with time information that specifies time, and with a customer identifier, to function as: a gas information reception unit that receives gas information that is associated with a customer identifier, from a gas information transmission apparatus that includes a terminal acquisition unit that acquires gas information that is information that includes gas use information regarding use of gas in an LPG cylinder and corresponds to a customer identifier, and a terminal transmission unit that transmits the gas information acquired by the terminal acquisition unit to the information processing apparatus; a gas information accumulation unit that accumulates the gas information received by the gas information reception unit, in the gas information storage unit in association with time information, and with a customer identifier; and a processing unit that performs predetermined processing, using two or more pieces of gas information stored in the gas information storage unit.

### Embodiment 2

The present embodiment describes an information system that includes an information processing apparatus that acquires and outputs credit rating information regarding household credit rating, using gas information that contains gas use information regarding the use of gas. In the present embodiment, gas information includes, for example, one or more pieces of information of: a gas supply category; a payment category; a housing category; and a gas use fee category. Gas use fee category is one example information of the above-described gas use information. Furthermore, in the present embodiment, gas information may also be referred to as gas customer information.

The present embodiment also describes an information system that includes an information processing apparatus that acquires and outputs credit rating information, using electricity customer information regarding the use of electricity. Note that electricity customer information includes one or more pieces of information of: an electricity supply category; a payment category; a housing category; and an electricity use fee category.

The present embodiment also describes an information system that includes an information processing apparatus that acquires and outputs credit rating information, using water service customer information regarding the use of water service. Note that water service customer information includes one or more pieces of information of: a water service supply category; a payment category; a housing category; and a water service use fee category.

The present embodiment also describes an information system that includes an information processing apparatus that acquires and outputs credit rating information, using bank customer information regarding a bank account. It is preferable that bank customer information that is used to calculate credit rating information is bank customer information regarding two or more families that belong to one household. In addition, bank customer information includes, for example, one or more pieces of information of: the amount of bank account activity; a deposit balance; a housing category; the presence or absence of a credit card; and the presence or absence of a safe deposit box.

The present embodiment also describes an information system that includes an information processing apparatus that acquires and outputs credit rating information, using mobile customer information regarding the use of a mobile. It is preferable that mobile customer information that is used to calculate credit rating information is mobile customer information regarding two or more families that belong to one household. Mobile customer information employs, for example, one or more pieces of information of: a payment history; and a use status.

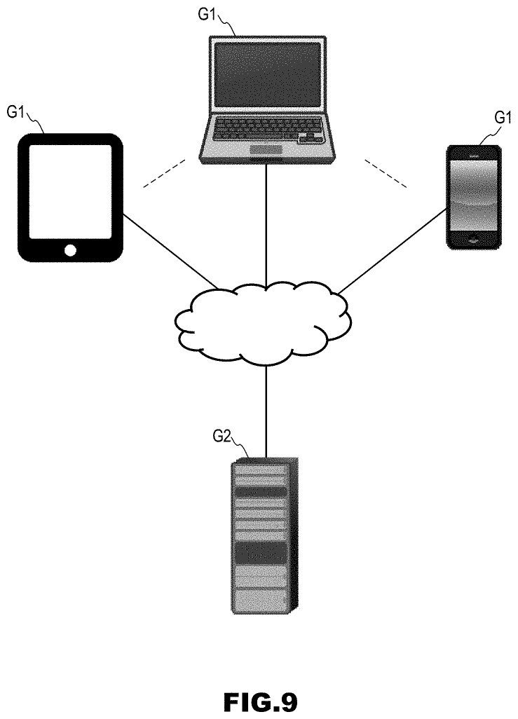

FIG. 9 is a conceptual diagram for an information system G according to the present embodiment. The information system G includes one or more terminal apparatuses G1 and an information processing apparatus G2. The terminal apparatuses G1 are terminals that output credit rating information. The terminal apparatuses G1 are, for example, smartphones, tablet terminals, so-called personal computers, or the like, but there is no limitation on the type thereof. The information processing apparatus G2 is an apparatus for acquiring credit rating information. The information processing apparatus G2 can be realized using a so-called cloud server or an ASP server, but there is no limitation on the type thereof.

The information processing apparatus G2 may have some or all of the functions of the information processing apparatus A2. That is to say, the information processing apparatus G2 is an information processing apparatus A2 that performs household credit rating acquisition processing.

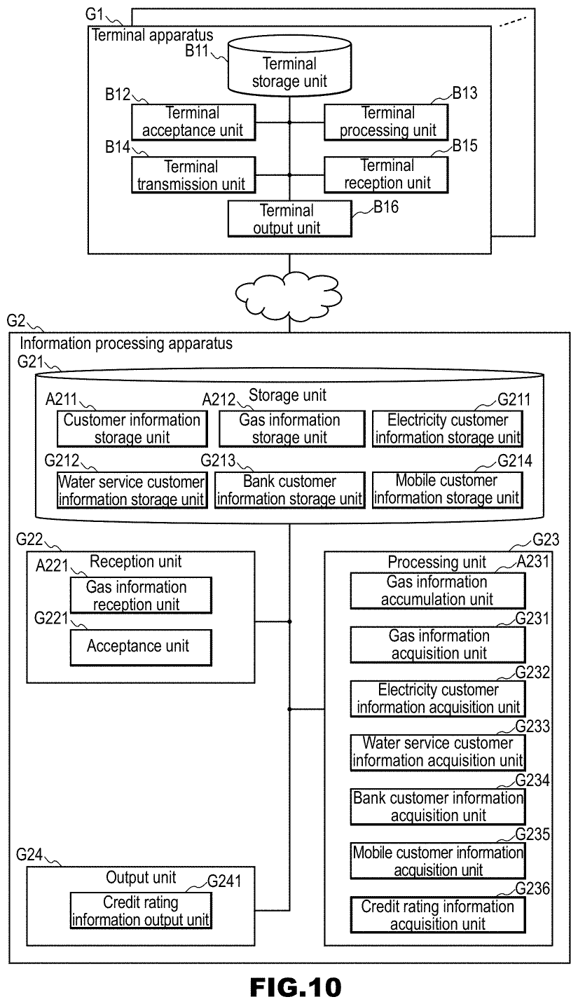

FIG. 10 is a block diagram for the information system G according to the present embodiment.

The terminal apparatuses G1 included in the information system G each include a terminal storage unit G11, a terminal acceptance unit G12, a terminal processing unit G13, a terminal transmission unit G14, a terminal reception unit G15, and a terminal output unit G16.

The information processing apparatus G2 includes a storage unit G21, a reception unit G22, a processing unit G23, and an output unit G24. The storage unit G21 includes the customer information storage unit A211, the gas information storage unit A212, an electricity customer information storage unit G211, a water service customer information storage unit G212, a bank customer information storage unit G213, and a mobile customer information storage unit G214. The reception unit G22 includes the gas information reception unit A221 and an acceptance unit G221. The processing unit G23 includes the gas information accumulation unit A231, a gas information acquisition unit G231, an electricity customer information acquisition unit G232, a water service customer information acquisition unit G233, a bank customer information acquisition unit G234, a mobile customer information acquisition unit G235, and a credit rating information acquisition unit G236. The output unit G24 includes a credit rating information output unit G241.

The terminal storage unit G11 included in each terminal apparatus G1 stores various kinds of information. Examples of the various kinds of information include a customer identifier. Note that a customer identifier typically is a household identifier that identifies a household. Here, a customer identifier is information that specifies the head of a household, for example.

The terminal acceptance unit G12 accepts instructions, information, and so on. Examples of instructions, information, and so on include a customer identifier and a credit rating acquisition instruction. A credit rating acquisition instruction is an instruction to perform household credit rating output processing. A credit rating acquisition instruction is an instruction to prompt to output a household credit rating. The credit rating acquisition instruction may contain a customer identifier that specifies a household for which a household credit rating is to be acquired, or may contain no customer identifier. If a credit rating acquisition instruction does not contain a customer identifier, the credit rating acquisition instruction is an instruction to acquire a credit rating information regarding the households identified by all of the customer identifiers that are under control, for example. Note that any input means may be employed to input an instruction, information, and so on, such as a touch panel, a keyboard, a mouse, a menu screen, or the like.

The terminal processing unit G13 performs various kinds of processing. Examples of the various kinds of information include processing that is performed to convert the instruction, information, and so on accepted by the terminal acceptance unit G12 to an instruction, information, and so on that have a data structure that is to be transmitted. Examples of the various kinds of processing also include processing that is performed to convert the information received by the terminal transmission unit G14 so as to have a data structure that is to be output.

The terminal transmission unit G14 transmits various kinds of instructions, information, and so on to the information processing apparatus G2. Examples of instructions, information, and so on include a customer identifier and a credit rating acquisition instruction.

The terminal reception unit G15 receives various kinds of information, and so on from the information processing apparatus G2. Examples of the various kinds of information and so on include a customer identifier and credit rating information. Credit rating information is information that specifies a credit rating of a household. credit rating information may be a numerical value or an English character. Credit rating information may be any information that indicates a rank.

The terminal output unit G16 outputs various kinds of information and so on. Examples of the various kinds of information and so on include a set of pieces of information composed of a customer identifier and credit rating information. Here, “output” typically means displaying on a display device, but may be regarded as a concept that includes projection with a projector, printing with a printer, sound output, transmission to an external device, accumulation on a recording medium, delivery of processing results to another processing apparatus or another program, and so on.

The storage unit G21 included in the information processing apparatus G2 stores various kinds of information. Examples of the various kinds of information include customer information described below and gas information.

The customer information storage unit A211 stores one or more pieces of customer information each in association with a customer identifier. Note that customer information is information regarding a customer, and is information paired with a customer identifier. For example, customer information contains one or more pieces of information of: LPG cylinder information that contains cylinder capacity information regarding the capacity of the LPG cylinder of the customer; cylinder type information that specifies the type of a gas cylinder that is used by the customer; number information that specifies the number of gas cylinders that are used by the customer; date information paired with the cylinder replacement information (information that specifies the day on which a cylinder was replaced); use amount value calculation formula described later; a name; customer position information (an address or position information (latitude,longitude); and contact information. Note that LPG cylinder information may be cylinder type information. Contact information is information that specifies a point of contact, and is, for example, an e-mail address or a telephone number.

The gas information storage unit A212 stores two or more pieces of gas information that include gas use information. The two or more pieces of gas information are each associated with a customer identifier.

Gas use information is information regarding the use of gas. Gas information includes, for example, information regarding the amount of gas used. Information regarding the amount of gas used includes, for example, gas use fee category information that specifies how high the gas use fee is. Gas information contains, in addition to gas use fee category information, one or more pieces of information of: gas supply category information that specifies the type of gas that is supplied; gas payment category information that specifies a means for payment of the gas fee; and housing category information that specifies the type of the housing of the customer. Note that housing category information may be contained in customer information.

Gas use fee category information is information that specifies, for example, one of “low”, “standard”, “high”, and so on. “Low” is information indicating, for example, when compared to a reference amount of use [X] (for example, the average of all households), that “X×n>the amount of use” or “X×n>=the amount of use” (n is a number less than 1) is satisfied. “Standard” is information indicating that the difference from the reference amount of use is a difference within a threshold percentage. “High” is information indicating, for example, when compared to the reference amount of use [X], that “X×(1+m)<the amount of use” or “X×(1+m)>=the amount of use” (m is a number less than 1) is satisfied. Needless to say, gas use fee category information may be classified into four or more categories or two categories instead of three categories. Note that gas use fee category information is information acquired by the processing unit G23 using the amount of gas used specified by the gas use information paired with the customer identifier and the reference amount of use [X]. For example, “low” corresponds to “1”, “standard” corresponds to “2”, and “high” corresponds to “3”.

Gas supply category information is information that specifies any one of “liquid petroleum”, “simple gas”, “city gas”, and so on, for example. “Liquid petroleum” is information indicating that the type of gas is liquid petroleum. “Simple gas” is information indicating that the type of gas is simple gas. “City gas” is information indicating that the type of gas is city gas. For example, “liquid petroleum” corresponds to a value “1”, “simple gas” corresponds to a value “2”, and “city gas” corresponds to a value “3”.

Gas payment category information is information that specifies any one of “credit”, “Japan Post Bank”, “bank”, “collection”, “transfer”, and so on. Note that “credit” is information indicating that payment is made by credit card, “Japan Post Bank” is information indicating that payment is made from postal savings (usually, withdrawal from the postal savings account), “bank” is information indicating that payment is made from a bank deposit (usually withdrawal from a bank account), “collection” is information indicating that payment is made by collection, and “transfer” is information indicating that payment is made by transfer. For example, “credit” corresponds to a value “1”, “Japan Post Bank” corresponds to a value “2”, “bank” corresponds to a value “3”, “collection” corresponds to a value “4”, “transfer” corresponds to a value “5”, and so on.

Housing category information is information that specifies any one of “apartment”, “public/municipal/prefectural housing”, “owned apartment”, “owned house”, “company housing/apartment”, “rental house”, and so on. “Apartment” is information indicating that housing is a rental apartment, “public/municipal/prefectural housing” is information indicating that housing is public/municipal/prefectural housing, “owned apartment” is information indicating that housing is owned apartment, “owned house” is information indicating that housing is owned house, “company housing/apartment” is information indicating that housing is company housing/apartment, and “rental house” is information indicating that housing is a rental house. For example, “apartment” corresponds to a value “1”, “public/municipal/prefectural housing” corresponds to a value “2”, “owned apartment” corresponds to a value “3”, “owned house” corresponds to a value “4”, “company housing/apartment” corresponds to a value “5”, “rental house” corresponds to a value “6”, and so on.

The electricity customer information storage unit G211 stores two or more pieces of electricity customer information. The two or more pieces of electricity customer information are each associated with a customer identifier. Note that the two or more pieces of electricity customer information are pieces of information acquired from an external server apparatus (not shown) (for example, an electricity company server), for example.

Electricity customer information is information regarding electricity for a customer. Electricity customer information includes electricity use information regarding the use of electricity by a customer. Electricity use information is, for example, electricity use fee category information described later.

It is preferable that electricity customer information contains one or more pieces of information of: electricity supply category information that specifies the type of electricity supplied; electricity payment category information that specifies a means for payment of an electricity fee; housing category information that specifies the type of housing of a customer; and electricity use fee category information that specifies how high the electricity use fee is.

Electricity supply category information is information that specifies any one of, for example, “general electricity company”, “wholesale electricity company”, “specific scale electricity company”, and so on. “General electricity company” is information indicating that the electricity supplier company is a general electricity company. “Wholesale electricity company” is information indicating that the electricity supplier company is a wholesale electricity company. “Specific scale electricity company” is information indicating that the electricity supplier company is a specific scale electricity company. For example, “general electricity company” corresponds to a value “1”, “wholesale electricity company” corresponds to a value “2”, “specific scale electricity company” corresponds to a value “3”, and so on.

Electricity payment category information is information that specifies any one of “credit”, “Japan Post Bank”, “bank”, “collection”, “transfer”, and so on.

Housing category information is information that specifies any one of “apartment”, “public/municipal/prefectural housing”, “owned apartment”, “owned house”, “company housing/apartment”, “rental house”, and so on.

Electricity use fee category information is information that specifies, for example, one of “low”, “standard”, “high”, and so on. “Low” is information indicating, for example, when compared to a reference amount of use [X] (for example, the average of all households), that “X×n>the amount of use” or “X×n>=the amount of use” (n is a number less than 1) is satisfied. “Standard” is information indicating that the difference from the reference amount of use is a difference within a threshold percentage. “High” is information indicating, for example, when compared to the reference amount of use [X], that “X×(1+m)<the amount of use” or “X×(1+m)>=the amount of use” (m is a number less than 1) is satisfied. Needless to say, electricity use fee category information may be classified into four or more categories or two categories instead of three categories. Electricity use fee category information is stored in association with a customer identifier. Note that electricity use fee category information is information acquired by the processing unit G23 using the amount of electricity used specified by the electricity use information paired with the customer identifier and the reference amount of use [X]. For example, “low” corresponds to “1”, “standard” corresponds to “2”, and “high” corresponds to “3”.

The water service customer information storage unit G212 stores two or more pieces of water service customer information. The two or more pieces of water service customer information are each associated with a customer identifier. Note that the two or more pieces of water service customer information are pieces of information acquired from an external server apparatus (not shown) (for example, a water service company server), for example.

Water service customer information is information regarding water service for a customer. Water service customer information includes water service use information regarding the use of water service by a customer. Water service use information is, for example, water service use fee category information described later.

It is preferable that water service customer information contains one or more pieces of information of: water service supply category information that specifies the type of water service supplied; water service payment category information that specifies a means for payment of water service fee; housing category information that specifies the type of housing of a customer; and water service use fee category information that specifies how high the water service use fee is.

Water service supply category information is, for example, information that specifies any one of “water supply”, “simple water supply”, “dedicated water supply”, and so on. “Water supply” is information indicating a water supply business. “Simple water supply” is information indicating a simple water supply business. “Dedicated water supply” is information indicating dedicated water supply. For example, “water supply” corresponds to a value “1”, “simple water supply” corresponds to a value “2”, and “dedicated water supply” corresponds to a value “3”.

Water service payment category information is information that specifies any one of “credit”, “Japan Post Bank”, “bank”, “collection”, “transfer”, and so on.

Housing category information is information that specifies any one of “apartment”, “public/municipal/prefectural housing”, “owned apartment”, “owned house”, “company housing/apartment”, “rental house”, and so on.

Water service use fee category information is information that specifies, for example, one of “low”, “standard”, “high”, and so on. “Low” is information indicating, for example, when compared to a reference amount of use [X] (for example, the average of all households), that “X×n>the amount of use” or “X×n>=the amount of use” (n is a number less than 1) is satisfied. “Standard” is information indicating that the difference from the reference amount of use is a difference within a threshold percentage. “High” is information indicating, for example, when compared to the reference amount of use [X], that “X×(1+m)<the amount of use” or “X×(1+m)>=the amount of use” (m is a number less than 1) is satisfied. Needless to say, water service use fee category information may be classified into four or more categories or two categories instead of three categories. Water service use fee category information is stored in association with a customer identifier. Note that water service use fee category information is information acquired by the processing unit G23 using the amount of water used specified by the water service use information paired with the customer identifier and the reference amount of use [X]. For example, “low” corresponds to “1”, “standard” corresponds to “2”, and “high” corresponds to “3”.

The bank customer information storage unit G213 stores two or more pieces of bank customer information. The two or more pieces of bank customer information are each associated with a customer identifier. Note that the two or more pieces of bank customer information are pieces of information acquired from an external server apparatus (not shown) (for example, a bank server), for example.

Bank customer information is information regarding a bank account of a customer. Bank customer information contains, for example, one or more pieces of information of: the amount of bank account activity; a deposit balance; a housing category; the presence or absence of a credit card; and the presence or absence of a safe deposit box.

The bank customer information storage unit G213 may store one or more pieces of bank customer information that are associated with a personal identifier that is paired with the same customer identifier. For example, the customer identifier is the identifier of the head of the household, and the personal identifier is the identifier of the family member of the household identified by the customer identifier. Also, for example, the correspondence between the customer identifier and one or more personal identifiers is stored in the storage unit A21.

The mobile customer information storage unit G214 stores two or more pieces of mobile customer information. The two or more pieces of mobile customer information are each associated with a customer identifier. Note that the two or more pieces of mobile customer information are pieces of information acquired from an external server apparatus (not shown) (for example, a mobile company server), for example.

Mobile customer information contains one or more pieces of information of: mobile payment history information regarding mobile bill payment history; and mobile use status information regarding mobile use status. Mobile payment history information is, for example, one or more pieces of information of: total payment information indicating the total amount of payment; maximum amount information indicating the maximum amount of monthly payment; unit period total payment information indicating the total amount of payment for a unit period; overdue count information indicating the number of times mobile payment have been overdue; an overdue flag indicating whether or not mobile payment has been overdue, and so on. Mobile use status information is, for example, one or more pieces of information of: use period information indicating the mobile use period; data amount information indicating the monthly data amount of the mobile; and so on.

The mobile customer information storage unit G214 may store one or more pieces of mobile customer information that are associated with a personal identifier that is paired with the same customer identifier.

Note that a different customer identifier may be paired with gas information, electricity customer information, water service customer information, bank customer information, and mobile customer information. However, even if the customer identifiers are different, it is preferable that the customer identifiers are associated. Association with a customer identifier means, for example, association with a common identifier, establishment of a link between customer identifiers, and so on.

The reception unit G22 receives various kinds of information. Examples of the various kinds of information includes a customer identifier, a credit rating acquisition instruction, gas information, electricity customer information, water service customer information, bank customer information, and mobile customer information.

The acceptance unit G221 accepts various instructions and various kinds of information. Examples of the various instructions and various kinds of information include a customer identifier and a credit rating acquisition instruction. Here, acceptance typically is reception, but may be acceptance of an input from a user.

The acceptance of a customer identifier by the acceptance unit G221 may be acquisition of a customer identifier. For example, the acceptance unit G221 may receive a credit rating acquisition instruction, and acquire one or more customer identifiers corresponding to the credit rating acquisition instruction, to accept one or more customer identifiers. One or more customer identifiers corresponding to the credit rating acquisition instruction is one or more customer identifier included in the credit rating acquisition instruction, or, when no customer identifier is included in the credit rating acquisition instruction, one or more predetermined customer identifiers (for example, all of the customer identifiers that are under control).

The processing unit G23 performs various kinds of processing. Examples of the various kinds of processing include processing that is performed by the gas information accumulation unit A231, processing that is performed by the gas information acquisition unit G231, processing that is performed by the electricity customer information acquisition unit G232, processing that is performed by the water service customer information acquisition unit G233, processing that is performed by the bank customer information acquisition unit G234, processing that is performed by the mobile customer information acquisition unit G235, and processing that is performed by the credit rating information acquisition unit G236.

The gas information acquisition unit G231 acquires one or more pieces of gas information associated with the same customer identifier as the customer identifier accepted by the acceptance unit G221. Note that the gas information acquisition unit G231 typically acquires one or more pieces of gas information from the gas information storage unit A212. However, the gas information acquisition unit G231 may acquire one or more pieces of gas information from an external server (not shown). Note that acquisition of gas information may be acquisition of only part of the information included in gas information. Acquisition of gas information may be acquisition of gas use information, for example.

The electricity customer information acquisition unit G232 acquires electricity customer information associated with the same customer identifier as the customer identifier accepted by the acceptance unit G221. Note that the electricity customer information acquisition unit G232 acquires one or more pieces of electricity customer information from the electricity customer information storage unit G211. However, the electricity customer information acquisition unit G232 may acquire one or more pieces of electricity customer information from an external server (not shown). Note that acquisition of electricity customer information may be acquisition of only part of the information included in electricity customer information. Acquisition of electricity customer information may be acquisition of electricity use information, for example.

The water service customer information acquisition unit G233 acquires water service customer information associated with the same customer identifier as the customer identifier accepted by the acceptance unit G221. Note that the water service customer information acquisition unit G233 typically acquires one or more pieces of water service customer information from the water service customer information storage unit G212. However, the water service information acquisition unit G233 may acquire one or more pieces of water service customer information from an external server (not shown). Note that acquisition of water service customer information may be acquisition of only part of the information included in water service customer information. Acquisition of water service customer information may be acquisition of water service use information, for example.

The bank customer information acquisition unit G234 acquires bank customer information associated with the same customer identifier as the customer identifier accepted by the acceptance unit G221. Note that the bank service customer information acquisition unit G234 typically acquires one or more pieces of bank customer information from the bank customer information storage unit G213. However, the bank customer information acquisition unit G234 may acquire one or more pieces of bank customer information from an external server (not shown). Also, acquisition of bank customer information may be acquisition of only part of the information included in bank customer information.

It is preferable that the bank customer information acquisition unit G234 acquires two or more pieces of bank customer information that are associated with two or more personal identifiers that are paired with the same customer identifier as the customer identifier accepted by the acceptance unit G221.

The bank customer information acquisition unit G235 acquires mobile customer information that is associated with a personal identifier that is paired with the same customer identifier as the customer identifier accepted by the acceptance unit G221. Note that the mobile customer information acquisition unit G235 typically acquires one or more pieces of mobile customer information from the mobile customer information storage unit G214. However, the mobile customer information acquisition unit G235 may acquire one or more pieces of bank customer information from an external server (not shown). Also, acquisition of mobile customer information may be acquisition of only part of the information included in mobile customer information.

It is preferable that the mobile customer information acquisition unit G235 acquires two or more pieces of mobile customer information associated with two or more personal identifiers paired with the same customer identifier as the customer identifier accepted by the acceptance unit G221.

The credit rating information acquisition unit G236 acquires credit rating information that specifies the credit rating of the household identified by the customer identifier accepted by the acceptance unit G221, using one or more kinds of information of: the gas information acquired by the gas information acquisition unit G231; the electricity customer information acquired by the electricity customer information acquisition unit G232; the water service customer information acquired by the water service customer information acquisition unit G233; the bank customer information acquired by the bank customer information acquisition unit G234; and the mobile customer information acquired by the mobile customer information acquisition unit G235.

It is preferable that the credit rating information acquisition unit G236 acquires credit rating information that specifies the credit rating regarding the household identified by the customer identifier accepted by the acceptance unit G221, using the gas information acquired by the gas information acquisition unit G231.

The credit rating information acquisition unit G236 may acquire the credit rating information regarding the household, using one or more pieces of credit rating information of: credit rating information regarding gas described later; credit rating information regarding electricity described later; credit rating information regarding water service described later; credit rating information regarding bank described later; and credit rating information regarding a mobile described later. In such a case, machine learning algorithm may or may not be used to acquire one or more pieces of credit rating information regarding gas and so on. Also, in such a case, machine learning algorithm may or may not be used to acquire total credit rating information regarding a household. Note that credit rating information regarding gas may be referred to as a gas score, credit rating information regarding electricity may be referred to as an electricity charge score, credit rating information regarding water service may be referred to as a water service fee score, credit rating information regarding a bank may be referred to as a bank score, and credit rating information regarding a mobile may be referred to as a mobile score.

The credit rating information acquisition unit G236 may acquire the credit rating information regarding the household, using an increasing function (for example, a sum, a weighted average, or the like) that employs, as parameters, one or more pieces of credit rating information of: credit rating information regarding gas described later; credit rating information regarding electricity described later; credit rating information regarding water service described later; credit rating information regarding bank described later; and credit rating information regarding a mobile described later. In such a case, machine learning algorithm may or may not be used to acquire one or more pieces of credit rating information for gas and so on.

The following describes an example of processing in which the credit rating information acquisition unit G236 acquires credit rating information without using machine learning, and an example of processing in which the credit rating information acquisition unit G236 acquires credit rating information, using machine learning. Note that there is no limitation on the algorithm that the credit rating information acquisition unit G236 uses to acquire credit rating information. The credit rating information acquisition unit G236 may use one or more kinds of information of: gas information; electricity customer information; water service customer information; bank customer information; and mobile customer information to acquire credit rating information.

### (1) When Machine Learning is not Used to Acquire Credit Rating Information

The credit rating information acquisition unit G236 acquires credit rating information, using the gas use information acquired by the gas information acquisition unit G231. The credit rating information acquisition unit G236 acquires credit rating information such that the credit rating typically increases as the amount of use indicated by the gas use information increases. The credit rating information acquisition unit G236 acquires credit rating information, using an increasing function that employs gas use information as a parameter, for example. Note that information regarding such a function (information regarding a calculation formula) is stored in the storage unit G21.

It is preferable that the credit rating information acquisition unit G236 acquires credit rating information, using one or more pieces of information of: gas use information; gas supply category information; gas payment category information; and housing category information, for example. It is even more preferable that the credit rating information acquisition unit G236 acquires credit rating information, using, in addition to gas use information, one or more pieces of information of: gas supply category information; gas payment category information; and housing category information, for example.

The credit rating information acquisition unit G236 may acquire one or more partial scores of: a partial score corresponding to gas use information; a partial score corresponding to gas supply category information; a partial score corresponding to gas payment category information; and a partial score corresponding to housing category information, and acquire credit rating information regarding gas, using the one or more partial scores.

The credit rating information acquisition unit G236 may acquire credit rating information regarding gas, using a calculation formula (for example, a “sum” or an “average”) that employs two or more partial scores of: a partial score corresponding to gas use information; a partial score corresponding to gas supply category information; a partial score corresponding to gas payment category information; and a partial score corresponding to housing category information.

For example, the partial scores corresponding to the values of gas supply category information (for example, “liquid petroleum”, “simple gas”, and “city gas”) are stored in the storage unit G21, and the credit rating information acquisition unit G236 may determine the partial score corresponding to the gas supply category information with reference to such a correspondence table (a correspondence table of values and partial scores). Note that partial scores are scores based on which credit rating information is acquired.

Also, the credit rating information acquisition unit G236 acquires credit rating information, using a calculation formula that employs gas use information as a parameter, for example. In such a case, numeric values corresponding to the values of gas supply category information are stored in the storage unit G21.

It is preferable that the credit rating information acquisition unit G236 acquires partial scores that satisfy (“simple gas”<“liquid petroleum”<“city gas”) as partial scores corresponding to gas supply category information, for example.

For example, the partial scores corresponding to the values of gas payment category information (for example, “credit”, “Japan Post Bank”, “bank”, “collection”, and “transfer”) are stored in the storage unit G21, and the credit rating information acquisition unit G236 may determine the partial score corresponding to the gas payment category information with reference to such a correspondence table (a correspondence table of values and partial scores).

Also, the credit rating information acquisition unit G236 acquires credit rating information, using a calculation formula that employs gas payment category information as a parameter, for example. In such a case, numeric values corresponding to the values of gas payment category information are stored in the storage unit G21.

It is preferable that the credit rating information acquisition unit G236 acquires partial scores that satisfy (“collection”<“transfer” <“bank”<“Japan Post Bank”<“credit”) as partial scores corresponding to gas payment category information, for example.

Also, for example, partial scores corresponding to the values of housing category information (for example, “apartment”, “public/municipal/prefectural housing”, “owned apartment”, “owned house”, “company housing/apartment”, and “rental house”) are stored in the storage unit G21, and the credit rating information acquisition unit G236 may determine the partial score corresponding to the housing category information with reference to such a correspondence table (a correspondence table of values and partial scores).

Also, the credit rating information acquisition unit G236 acquires credit rating information, using a calculation formula that employs housing category information as a parameter, for example. In such a case, numeric values corresponding to the values of housing category information are stored in the storage unit G21.

It is preferable that the credit rating information acquisition unit G236 acquires partial scores that satisfy (“company housing/apartment”<“owned apartment”<“public/municipal/prefectural housing”<“rental house”<“apartment”<“owned house”) as partial scores corresponding to housing category information, for example.

It is preferable that the credit rating information acquisition unit G236 acquires credit rating information, using the electricity customer information acquired by the electricity customer information acquisition unit G232.

The credit rating information acquisition unit G236 acquires credit rating information such that the credit rating typically increases as the amount of electricity used specified by the information included in electricity customer information increases. The credit rating information acquisition unit G236 acquire, for example, credit rating information that indicates a higher credit rating as the electricity fee indicated by electricity use fee category information increases.

It is preferable that the credit rating information acquisition unit G236 acquires credit rating information, using one or more pieces of information of: electricity use fee category information; electricity supply category information; electricity payment category information; and housing category information, for example.

The credit rating information acquisition unit G236 may acquire one or more partial scores of: a partial score corresponding to electricity use fee category information; a partial score corresponding to electricity supply category information; a partial score corresponding to electricity payment category information; and a partial score corresponding to housing category information, and acquire credit rating information regarding electricity, using the one or more partial scores.

For example, partial scores corresponding to the values of electricity supply category information are stored in the storage unit G21, and the credit rating information acquisition unit G236 may determine the partial score corresponding to the electricity supply category information with reference to such a correspondence table (a correspondence table of values and partial scores).

Also, the credit rating information acquisition unit G236 acquires credit rating information, using a calculation formula that employs electricity supply category information as a parameter, for example. In such a case, numeric values corresponding to the values of electricity supply category information are stored in the storage unit G21.

It is preferable that the credit rating information acquisition unit G236 acquires partial scores that satisfy (“general electricity company”<“wholesale electricity company”<“specific scale electricity company”) as partial scores corresponding to electricity supply category information, for example.

Also, for example, the partial scores corresponding to the values of electricity payment category information (for example, “credit”, “Japan Post Bank”, “bank”, “collection”, and “transfer”) are stored in the storage unit G21, and the credit rating information acquisition unit G236 may determine the partial score corresponding to the electricity payment category information with reference to such a correspondence table (a correspondence table of values and partial scores).

Also, the credit rating information acquisition unit G236 acquires credit rating information, using a calculation formula that employs electricity payment category information as a parameter, for example. In such a case, numeric values corresponding to the values of electricity payment category information are stored in the storage unit G21.

It is preferable that the credit rating information acquisition unit G236 acquires partial scores that satisfy (“collection”<“transfer” <“bank”<“Japan Post Bank”<“credit”) as partial scores corresponding to electricity payment category information, for example.

Also, for example, partial scores corresponding to the values of housing category information (for example, “apartment”, “public/municipal/prefectural housing”, “owned apartment”, “owned house”, “company housing/apartment”, and “rental house”) are stored in the storage unit G21, and the credit rating information acquisition unit G236 may determine the partial score regarding electricity corresponding to the housing category information with reference to such a correspondence table (a correspondence table of values and partial scores).

Also, the credit rating information acquisition unit G236 acquires credit rating information, using a calculation formula that employs housing category information as a parameter, for example. In such a case, numeric values corresponding to the values of housing category information are stored in the storage unit G21.

It is preferable that the credit rating information acquisition unit G236 acquires partial scores regarding electricity that satisfy (“company housing/apartment”<“owned apartment”<“public/municipal/prefectural housing”<“rental house”<“apartment”<“owned house”) as partial scores corresponding to housing category information, for example.

It is preferable that the credit rating information acquisition unit G236 acquires credit rating information, using the water service customer information acquired by the water service customer information acquisition unit G233.

The credit rating information acquisition unit G236 acquires credit rating information such that the credit rating typically increases as the amount of water used specified by the information included in water service customer information increases. The credit rating information acquisition unit G236 acquire, for example, credit rating information that indicates a higher credit rating as the water service fee indicated by water service use fee category information increases.

It is preferable that the credit rating information acquisition unit G236 acquires credit rating information, using one or more pieces of information of: water service use fee category information; water service supply category information; water service payment category information; and housing category information, for example.

The credit rating information acquisition unit G236 may acquire one or more partial scores of: a partial score corresponding to water service use fee category information; a partial score corresponding to water service supply category information; a partial score corresponding to water service payment category information; and a partial score corresponding to housing category information, and acquire credit rating information regarding water service, using the one or more partial scores.

For example, partial scores corresponding to the values of water service supply category information are stored in the storage unit G21, and the credit rating information acquisition unit G236 may determine the partial score corresponding to the water service supply category information with reference to such a correspondence table (a correspondence table of values and partial scores).

Also, the credit rating information acquisition unit G236 acquires credit rating information, using a calculation formula that employs water service supply category information as a parameter, for example. In such a case, numeric values corresponding to the values of water service supply category information are stored in the storage unit G21.

It is preferable that the credit rating information acquisition unit G236 acquires partial scores that satisfy (“dedicated water supply”<“simple water supply”<“water supply”) as partial scores corresponding to water service supply category information, for example.

Also, for example, the partial scores corresponding to the values of water service payment category (for example, “credit”, “Japan Post Bank”, “bank”, “collection”, and “transfer”) are stored in the storage unit G21, and the credit rating information acquisition unit G236 may determine the partial score corresponding to the water service payment category information with reference to such a correspondence table (a correspondence table of values and partial scores).

Also, the credit rating information acquisition unit G236 acquires credit rating information, using a calculation formula that employs water service payment category information as a parameter, for example. In such a case, numeric values corresponding to the values of water service payment category information are stored in the storage unit G21.

It is preferable that the credit rating information acquisition unit G236 acquires partial scores that satisfy (“collection”<“transfer” <“bank”<“Japan Post Bank”<“credit”) as partial scores corresponding to water service payment category information, for example.

Also, for example, partial scores corresponding to the values of housing category information (for example, “apartment”, “public/municipal/prefectural housing”, “owned apartment”, “owned house”, “company housing/apartment”, and “rental house”) are stored in the storage unit G21, and the credit rating information acquisition unit G236 may determine the partial score regarding water service corresponding to the housing category information with reference to such a correspondence table (a correspondence table of values and partial scores).

Also, the credit rating information acquisition unit G236 acquires credit rating information, using a calculation formula that employs housing category information as a parameter, for example. In such a case, numeric values corresponding to the values of housing category information are stored in the storage unit G21.

It is preferable that the credit rating information acquisition unit G236 acquires partial scores that satisfy (“company housing/apartment”<“owned apartment”<“public/municipal/prefectural housing”<“rental house”<“apartment”<“owned house”) as partial scores for water service corresponding to housing category information, for example.

It is preferable that the credit rating information acquisition unit G236 acquires credit rating information, using the bank customer information acquired by the bank customer information acquisition unit G234.

The credit rating information acquisition unit G236 acquires credit rating information such that the credit rating typically increases as “the amount of bank account activity” or “the deposit balance” specified by the information included in bank customer information increases. The credit rating information acquisition unit G236 acquires credit rating information, using an increasing function that employs “the amount of bank account activity” or “the deposit balance” as a parameter, for example.

It is preferable that the credit rating information acquisition unit G236 acquires credit rating information, using one or more pieces of information of: the amount of bank account activity; the deposit balance; housing category information that specifies the type of housing of the customer; the presence or absence of a credit card; and the presence or absence of a safe deposit box, for example.

The credit rating information acquisition unit G236 acquires credit rating information such that the credit rating typically is higher when the information included in the bank customer information is “the presence of a credit card” than when the information is “the absence of a credit card”.

The credit rating information acquisition unit G236 acquires credit rating information such that the credit rating typically is higher when the information included in the bank customer information is “the presence of a safe deposit box” than when the information is “the absence of a safe deposit box”.

The credit rating information acquisition unit G236 may acquire one or more partial scores of: a partial score corresponding to the amount of bank account activity; a partial score corresponding to the deposit balance; a partial score corresponding to housing category information; a partial score corresponding to the presence or absence of a credit card; and a partial score corresponding to the presence or absence of a safe deposit box, and acquire credit rating information regarding the bank, using the one or more partial scores.

Also, for example, partial scores corresponding to the values of housing category information (for example, “apartment”, “public/municipal/prefectural housing”, “owned apartment”, “owned house”, “company housing/apartment”, and “rental house”) are stored in the storage unit G21, and the credit rating information acquisition unit G236 may determine the partial score regarding the bank corresponding to housing category information with reference to such a correspondence table (a correspondence table of values and partial scores).

Also, the credit rating information acquisition unit G236 acquires credit rating information, using a calculation formula that employs housing category information as a parameter, for example. In such a case, numeric values corresponding to the values of housing category information are stored in the storage unit G21.

It is preferable that the credit rating information acquisition unit G236 acquires partial scores that satisfy (“company housing/apartment”<“owned apartment”<“public/municipal/prefectural housing”<“rental house”<“apartment”<“owned house”) as partial scores regarding a bank corresponding to housing category information, for example.

It is preferable that the credit rating information acquisition unit G236 acquires credit rating information, using two or more pieces of bank customer information acquired by the bank customer information acquisition unit G234. The two or more pieces of bank customer information are bank customer information paired with a customer identifier or a bank customer information paired with a personal identifier paired with a customer identifier.

The credit rating information acquisition unit G236 may acquire credit rating information corresponding to the two or more pieces of bank customer information acquired by the bank customer information acquisition unit G234, and acquire the credit rating information for the household, using an increasing function that employs the two or more pieces of credit rating information as parameters. Such credit rating information may be credit rating information regarding a bank. Examples of operations performed using the increasing function include a sum operation, an average value calculation operation, an operation for acquiring the maximum value, an operation for acquiring the minimum value, and so on.

It is preferable that the credit rating information acquisition unit G236 acquires credit rating information, using mobile customer information acquired by the mobile customer information acquisition unit G235.

The credit rating information acquisition unit G236 acquires credit rating information that typically indicates a higher credit rating as the payment specified by mobile payment history information increases. If mobile payment history information is information that indicates that the payment was not overdue, the credit rating information acquisition unit G236 typically acquires credit rating information that indicates a higher credit rating compared to when mobile payment history information is information that indicates the payment was overdue.

The credit rating information acquisition unit G236 acquires credit rating information that typically indicates a higher credit rating as the amount of use indicated by mobile use status information increases as (the period increases, as the data amount increases, or the like).

It is preferable that the credit rating information acquisition unit G236 acquires credit rating information, using two or more pieces of mobile customer information acquired by the mobile customer information acquisition unit G235. The two or more pieces of mobile customer information are bank customer information paired with a customer identifier or a mobile customer information paired with a personal identifier paired with a customer identifier.

The credit rating information acquisition unit G236 may acquire credit rating information corresponding to the two or more pieces of mobile customer information acquired by the mobile customer information acquisition unit G235, and acquire the credit rating information for the household, using an increasing function that employs the two or more pieces of credit rating information as parameters. Such credit rating information may be credit rating information regarding a mobile.

### (2) When Machine Learning is Used to Acquire Credit Rating Information

(2-1) Processing that is Performed to Form Learner

It is assumed that two or more pieces of learning source information are stored in the storage unit G21. Learning source information is information used to create a learner. Learning source information contains, in addition to credit rating information that is associated with a customer identifier, one or more kinds of information of: gas information that is associated with a customer identifier; water service customer information that is associated with a customer identifier; bank customer information that is associated with a customer identifier; and mobile customer information that is associated with a customer identifier. Learning source information may also be referred to as teacher data.

The processing unit G23 acquires, from two or more pieces of learning source information, information that is to be input and credit rating information that is information that is to be output. Information that is to be input is one or more kinds of information of: information that is contained in gas information; information that is contained in water service customer information; information that is contained in bank customer information; and information that is contained in mobile customer information, and is information to be learned. Information that is to be input is one or more pieces of information of, for example: gas use information; gas supply category information; gas payment category information; housing category information; electricity supply category information; electricity payment category information; electricity use fee category information; water service supply category information; water service payment category information; water service use fee category information; the amount of bank account activity; the deposit balance; information that specifies the presence or absence of a credit card; information that specifies the presence or absence of a safe deposit box; mobile payment history information; and mobile use status information.

Next, the processing unit G23 acquires a plurality of sets consisting of information that is to be input and credit rating information that is information that is to be output, from the learning source information in the storage unit G21, provides the plurality of sets of pieces of information to a module for forming a learner for machine learning to form a learner, and accumulates it in the storage unit G21. Note that there is no limitation on the machine learning algorithm, which may be, for example, deep learning, random forest, SVR, or the like. In addition, the machine learning module may be any module, such as a TensorFlow module, fastText, TinySvm, any kind of RandomForest function, or the like. The learner may be referred to as a classifier.

### (2-1) Credit Rating Information Acquisition Processing

Next, the credit rating information acquisition unit G236 acquires one or more kinds of information of: gas information; electricity customer information; water service customer information; bank customer information; and mobile customer information paired with the customer identifier of the household for which credit rating information is to be acquired. It is preferable that the kind of information that is acquired here is the same as the kind of information that is used to form a learner.

Next, the credit rating information acquisition unit G236 acquires credit rating information according to a machine learning algorithm, using the acquired information and the accumulated learner. That is to say, for example, the credit rating information acquisition unit G236 forms a vector from the acquired information, provides the vector and the learner in the storage unit G21 to a module for performing prediction in machine learning, and acquires credit rating information, using a machine learning algorithm. Note that there is no limitation on the machine learning algorithm in the case of such prediction, which may be, for example, deep learning, random forest, SVR, or the like. In addition, the machine learning prediction module may be any module, such as a TensorFlow module, fastText, TinySvm, any kind of RandomForest function, or the like. Note that prediction here is processing that is performed to acquire credit rating information.

The output unit G24 outputs various kinds of information. Examples of the various kinds of information include credit rating information. In addition, “output” here means accumulation in the customer information storage unit A211, for example. In addition, “output” means display or transmission, for example. When “output” means display, the output unit G24 may be regarded as including or not including an output device such as a display or a speaker. The output unit G24 can be realized using the driver software of the output device, the driver software of the output device and the output device, or the like.

The credit rating information output unit G241 outputs the credit rating information acquired by the credit rating information acquisition unit G236. It is preferable that the credit rating information output unit G241 outputs credit rating information in association with a customer identifier.

It is preferable that the terminal storage unit G11, the storage unit G21, the electricity customer information storage unit G211, the water service customer information storage unit G212, the bank customer information storage unit G213, and the mobile customer information storage unit G214 are realized using a non-volatile recording medium, but they may be realized using a volatile recording medium.

There is no limitation on the process in which information is stored in the terminal storage unit G11 and so on. For example, information may be stored in the terminal storage unit G11 or the like via a recording medium, or information transmitted via a communication line or the like may be stored in the terminal storage unit G11 or the like, or information input via an input device may be stored in the terminal storage unit G11 or the like.

The terminal acceptance unit G12 can be realized using a device driver for the input means such as a touch panel or a keyboard, or control software or the like for controlling the menu screen.

The terminal processing unit G13, the processing unit G23, the gas information acquisition unit G231, the electricity customer information acquisition unit G232, the water service customer information acquisition unit G233, the bank customer information acquisition unit G234, the mobile customer information acquisition unit G235 and the credit rating information acquisition unit G236 can typically be realized using an MPU, a memory, or the like. The processing procedures performed by the terminal processing unit G13 and so on typically are realized using software, and the software is recorded on a recording medium such as a ROM. However, such processing procedures may be realized using hardware (a dedicated circuit).

The terminal transmission unit G14, the output unit G24, and the credit rating information output unit G241 typically are realized using a wireless or wired communication means, but may be realized using a broadcast means.

The terminal reception unit G15, the reception unit G22, and the acceptance unit G221 typically are realized using a wireless or wired communication means, but may be realized using a means for receiving broadcast.

The terminal output unit G16 may be regarded as including or not including an output device such as a display or a speaker. The terminal output unit G16 can be realized using the driver software of the output device, the driver software of the output device and the output device, or the like.

Next, operations that are performed by the information system G will be described. First, operations that are performed by the terminal apparatuses G1 will be described.

The terminal acceptance unit G12 of each of the terminal apparatuses G1 accepts a credit rating acquisition instruction. Next, the terminal processing unit G13 forms a credit rating acquisition instruction that is to be transmitted. Next, the terminal transmission unit G14 transmits the formed credit rating acquisition instruction to the information processing apparatus G2. Next, the terminal reception unit G15 receives credit rating information for each customer corresponding to the credit rating acquisition instruction. Thereafter, the terminal processing unit G13 forms information that is to be output, using the credit rating information for each customer thus received. Next, the terminal output unit G16 outputs credit rating information for each customer.

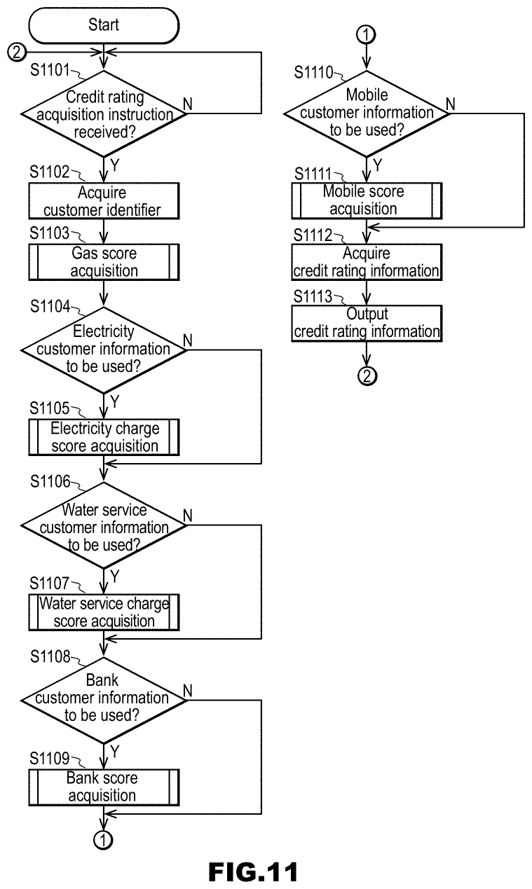

Next, an example of household credit rating acquisition processing that is performed by the information processing apparatus G2 will be described with reference to the flowchart shown in FIG. 11.

(Step S1101) The acceptance unit G221 determines whether or not a credit rating acquisition instruction has been received from a terminal apparatus G1. If a credit rating acquisition instruction has been received, processing proceeds to Step S1102, and if a credit rating acquisition instruction has not been received, processing returns to Step S1101.

(Step S1102) The processing unit G23 acquires a customer identifier that is contained in the credit rating acquisition instruction received in Step S1101.

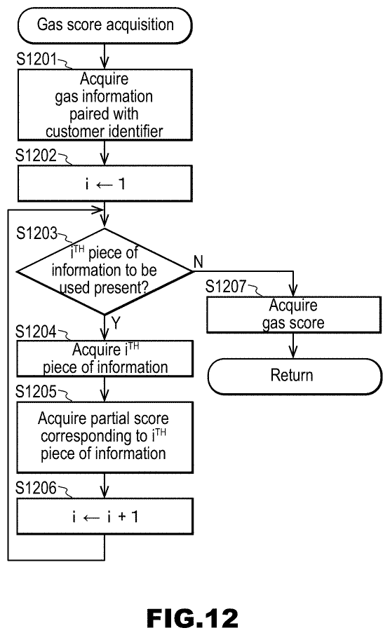

(Step S1103) The credit rating information acquisition unit G236 acquires a gas score. Gas score acquisition processing will be described with reference to the flowchart shown in FIG. 12.

(Step S1104) When acquiring credit rating information, the credit rating information acquisition unit G236 determines whether or not to use electricity customer information. When electricity customer information is to be used, processing proceeds to Step S1105, and when electricity customer information is not to be used, processing proceeds to Step S1106. Note that, for example, whether or not electricity customer information is to be used has been determined in advance or is determined by a user instruction or the like.

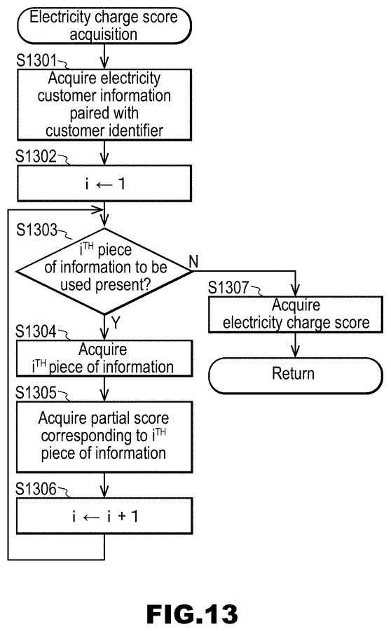

(Step S1105) The credit rating information acquisition unit G236 acquires an electricity score. Electricity charge score acquisition processing will be described with reference to the flowchart shown in FIG. 13.

(Step S1106) When acquiring credit rating information, the credit rating information acquisition unit G236 determines whether or not to use water service customer information. When water service customer information is to be used, processing proceeds to Step S1107, and when water service customer information is not to be used, processing proceeds to Step S1108. Note that, for example, whether or not water service customer information is to be used has been determined in advance or is determined by a user instruction or the like.

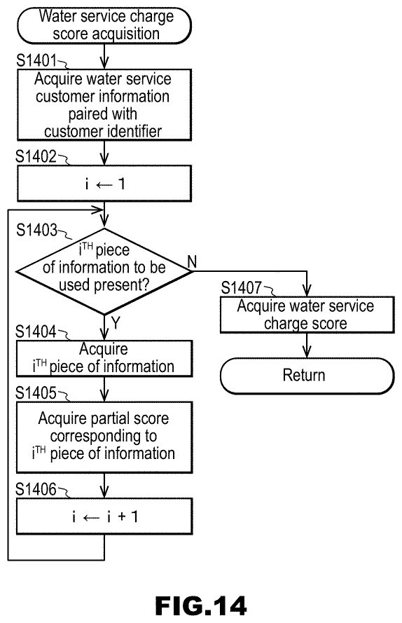

(Step S1107) The credit rating information acquisition unit G236 acquires a water service charge score. Water service charge score acquisition processing will be described with reference to the flowchart shown in FIG. 14.

(Step S1108) When acquiring credit rating information, the credit rating information acquisition unit G236 determines whether or not to use bank customer information. When bank customer information is to be used, processing proceeds to Step S1109, and when bank customer information is not to be used, processing proceeds to Step S1110. Note that, for example, whether or not bank customer information is to be used has been determined in advance or is determined by a user instruction or the like.

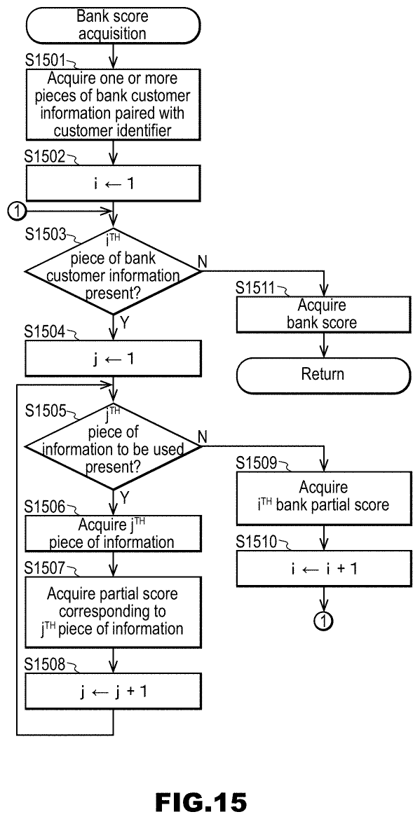

(Step S1109) The credit rating information acquisition unit G236 acquires a bank score. Bank score acquisition processing will be described with reference to the flowchart shown in FIG. 15.

(Step S1110) When acquiring credit rating information, the credit rating information acquisition unit G236 determines whether or not to use mobile customer information. When mobile customer information is to be used, processing proceeds to Step S1111, and when mobile customer information is not to be used, processing proceeds to Step S1112. Note that, for example, whether or not mobile customer information is to be used has been determined in advance or is determined by a user instruction or the like.

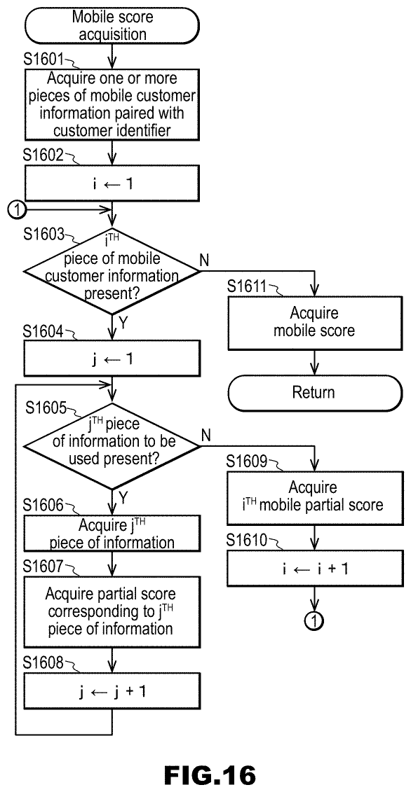

(Step S1111) The credit rating information acquisition unit G236 acquires a mobile score. Mobile score acquisition processing will be described with reference to the flowchart shown in FIG. 16.

(Step S1112) The credit rating information acquisition unit G236 acquires credit rating information, using the one or more scores thus acquired. The credit rating information acquisition unit G236 acquires credit rating information that typically indicates a higher credit rating as each of the one or more scores increases. If only one score has been acquired, this step may be omitted and the one score may be used as credit rating information.

(Step S1113) The credit rating information output unit G241 transmits the credit rating information acquired in Step S1112 to the terminal apparatus G1. Processing returns to Step S1101.

In the flowchart shown in FIG. 11, credit rating information may be acquired using other one or more scores without acquiring a gas score.

In the flowchart shown in FIG. 11, when credit rating information that corresponds to each of two or more customer identifiers, steps S4802 to S4813 are repeated for each customer identifier, for example.

In the flowchart shown in FIG. 11, processing is terminated when power is turned off or an interruption is made to terminate the processing.

Next, the gas score acquisition processing in Step S1103 will be described with reference to the flowchart shown in FIG. 12.

(Step S1201) The credit rating information acquisition unit G236 acquires gas information that is paired with the customer identifier acquired in Step S1102, from the gas information storage unit A212.

(Step S1202) The credit rating information acquisition unit G236 substitutes 1 for the counter i.

(Step S1203) The credit rating information acquisition unit G236 determines whether or not the i^{th} piece of information that is to be used to acquire a gas score is present in the pieces of gas information acquired in Step S1201. If the i^{th} piece of information is present, processing proceeds to Step S1204, and if the i^{th} piece of information is not present, processing proceeds to Step S1207.

(Step S1204) The credit rating information acquisition unit G236 acquires the i^{th} information of the pieces of gas information acquired in Step S1201.

(Step S1205) The credit rating information acquisition unit G236 acquires a partial score corresponding to the i^{th} piece of information acquired in Step S1204. Note that the credit rating information acquisition unit G236 acquires a partial score from a correspondence table in which two or more pieces of correspondence information that each contain information and a partial score in pair are stored, for example. Also, the credit rating information acquisition unit G236 provides the i^{th} piece of information to a calculation formula as a parameter, executes the calculation formula, and acquires a partial score, for example.

(Step S1206) The credit rating information acquisition unit G236 increments the counter i by 1. Processing returns to Step S1203.

(Step S1207) The credit rating information acquisition unit G236 acquires a gas score, using the one or more partial scores acquired in Step S1205, and at least temporarily accumulates it in the storage unit G21. Processing returns to higher level processing.

Note that the credit rating information acquisition unit G236 acquires a higher gas score as each of the one or more partial scores acquired in Step S1205 increases. The credit rating information acquisition unit G236 calculates a gas score, using an increasing function that employs the one or more partial scores acquired in Step S1205 as parameters.

Next, the electricity charge score acquisition processing in Step S1105 will be described with reference to the flowchart shown in FIG. 13.

(Step S1301) The credit rating information acquisition unit G236 acquires electricity customer information that is paired with the customer identifier acquired in Step S1102, from the electricity customer information storage unit G211.

(Step S1302) The credit rating information acquisition unit G236 substitutes 1 for the counter i.

(Step S1303) The credit rating information acquisition unit G236 determines whether or not the i^{th} piece of information that is to be used to acquire an electricity charge score is present in the pieces of electricity customer information acquired in Step S1301. If the i^{th} piece of information is present, processing proceeds to Step S1304, and if the i^{th} piece of information is not present, processing proceeds to Step S1307.

(Step S1304) The credit rating information acquisition unit G236 acquires the i^{th} information of the pieces of electricity customer information acquired in Step S1301.

(Step S1305) The credit rating information acquisition unit G236 acquires a partial score corresponding to the i^{th} piece of information acquired in Step S1304. Note that the credit rating information acquisition unit G236 acquires a partial score from a correspondence table in which two or more pieces of correspondence information that each contain information and a partial score in pair are stored, for example. Also, the credit rating information acquisition unit G236 provides the i^{th} piece of information to a calculation formula as a parameter, executes the calculation formula, and acquires a partial score, for example.

(Step S1306) The credit rating information acquisition unit G236 increments the counter i by 1. Processing returns to Step S1303.

(Step S1307) The credit rating information acquisition unit G236 acquires an electricity charge score, using the one or more partial scores acquired in Step S1305, and at least temporarily accumulates it in the storage unit G21. Processing returns to higher level processing.

Note that the credit rating information acquisition unit G236 acquires a higher electricity charge score as each of the one or more partial scores acquired in Step S1305 increases. The credit rating information acquisition unit G236 calculates an electricity charge score, using an increasing function that employs the one or more partial scores acquired in Step S1305 as parameters.

Next, the water service charge score acquisition processing in Step S1107 will be described with reference to the flowchart shown in FIG. 14.

(Step S1401) The credit rating information acquisition unit G236 acquires water service customer information that is paired with the customer identifier acquired in Step S1102, from the water service customer information storage unit G212.

(Step S1402) The credit rating information acquisition unit G236 substitutes 1 for the counter i.

(Step S1403) The credit rating information acquisition unit G236 determines whether or not the i^{th} piece of information that is to be used to acquire a water service charge score is present in the pieces of water service customer information acquired in Step S1401. If the i^{th} piece of information is present, processing proceeds to Step S1404, and if the i^{th} piece of information is not present, processing proceeds to Step S1407.

(Step S1404) The credit rating information acquisition unit G236 acquires the i^{th} information of the pieces of water service customer information acquired in Step S1401.

(Step S1405) The credit rating information acquisition unit G236 acquires a partial score corresponding to the i^{th} piece of information acquired in Step S1404. Note that the credit rating information acquisition unit G236 acquires a partial score from a correspondence table in which two or more pieces of correspondence information that each contain information and a partial score in pair are stored, for example. Also, the credit rating information acquisition unit G236 provides the i^{th} piece of information to a calculation formula as a parameter, executes the calculation formula, and acquires a partial score, for example.

(Step S1406) The credit rating information acquisition unit G236 increments the counter i by 1. Processing returns to Step S1403.

(Step S1407) The credit rating information acquisition unit G236 acquires a water service charge score, using the one or more partial scores acquired in Step S1405, and at least temporarily accumulates it in the storage unit G21. Processing returns to higher level processing.

Note that the credit rating information acquisition unit G236 acquires a higher water service charge score as each of the one or more partial scores acquired in Step S1405 increases. The credit rating information acquisition unit G236 calculates a water service score, using an increasing function that employs the one or more partial scores acquired in Step S1405 as parameters.

Next, the bank score acquisition processing in Step S1109 will be described with reference to the flowchart shown in FIG. 15.

(Step S1501) The credit rating information acquisition unit G236 acquires bank customer information that is paired with the customer identifier acquired in Step S1102, from the bank customer information storage unit G213.

(Step S1502) The credit rating information acquisition unit G236 substitutes 1 for the counter i.

(Step S1503) The credit rating information acquisition unit G236 determines whether or not the i^{th} piece of bank customer information is present in the pieces of bank customer information acquired in Step S1501. If the i^{th} piece of bank customer information is present, processing proceeds to Step S1504, and if the i^{th} piece of bank customer information is not present, processing proceeds to Step S1511.

(Step S1504) The credit rating information acquisition unit G236 substitutes 1 for the counter j.

(Step S1505) The credit rating information acquisition unit G236 determines whether or not the j^{th} piece of information that is to be used to acquire a bank score is present in the i^{th} piece of bank customer information acquired in Step S1501. If the j^{th} piece of information is present, processing proceeds to Step S1506, and if the j^{th} piece of information is not present, processing proceeds to Step S1509.

(Step S1506) The credit rating information acquisition unit G236 acquires the j^{th} piece of information of the i^{th} piece of bank customer information acquired in Step S1501.

(Step S1507) The credit rating information acquisition unit G236 acquires a partial score corresponding to the j^{th} piece of information acquired in Step S1506. Note that the credit rating information acquisition unit G236 acquires a partial score from a correspondence table in which two or more pieces of correspondence information that each contain information and a partial score in pair are stored, for example. Also, the credit rating information acquisition unit G236 provides the j^{th} piece of information to a calculation formula as a parameter, executes the calculation formula, and acquires a partial score, for example.

(Step S1508) The credit rating information acquisition unit G236 increments the counter j by 1. Processing returns to Step S1505.

(Step S1509) The credit rating information acquisition unit G236 acquires the i^{th} bank partial score, using the one or more partial scores acquired in Step S1507.

(Step S1510) The counter i is incremented by 1. Processing returns to Step S1503.

(Step S1511) The credit rating information acquisition unit G236 acquires a bank score, using the one or more bank partial scores acquired in Step S1509, and at least temporarily accumulates it in the storage unit G21. Processing returns to higher level processing.

Note that, in Step S1509, the credit rating information acquisition unit G236 acquires a higher bank score as each of the one or more partial scores acquired in Step S1507 increases. The credit rating information acquisition unit G236 calculates a bank partial score in Step S1509, using an increasing function that employs the one or more partial scores acquired in Step S1507 as parameters.

Note that the credit rating information acquisition unit G236 acquires a higher bank score as each of the one or more partial bank scores acquired in Step S1509 increases. The credit rating information acquisition unit G236 calculates a bank partial score, using an increasing function that employs the one or more partial bank scores acquired in Step S1509 as parameters.

Next, the mobile score acquisition processing in Step S1111 will be described with reference to the flowchart shown in FIG. 16.

(Step S1601) The credit rating information acquisition unit G236 acquires mobile customer information that is paired with the customer identifier acquired in Step S1102, from the mobile customer information storage unit G212.

(Step S1602) The credit rating information acquisition unit G236 substitutes 1 for the counter i.

(Step S1603) The credit rating information acquisition unit G236 determines whether or not the i^{th} piece of mobile customer information is present in the pieces of mobile customer information acquired in Step S1601. If the i^{th} piece of mobile customer information is present, processing proceeds to Step S1604, and if the i^{th} piece of mobile customer information is not present, processing proceeds to Step S1611.

(Step S1604) The credit rating information acquisition unit G236 substitutes 1 for the counter j.

(Step S1605) The credit rating information acquisition unit G236 determines whether or not the j^{th} piece of information that is to be used to acquire a mobile score is present in the i^{th} piece of mobile customer information acquired in Step S1601. If the j^{th} piece of information is present, processing proceeds to Step S1606, and if the j^{th} piece of information is not present, processing proceeds to Step S1609.

(Step S1606) The credit rating information acquisition unit G236 acquires the j^{th} piece of information of the i^{th} piece of mobile customer information acquired in Step S1601.

(Step S1607) The credit rating information acquisition unit G236 acquires a partial score corresponding to the j^{th} piece of information acquired in Step S1606. Note that the credit rating information acquisition unit G236 acquires a partial score from a correspondence table in which two or more pieces of correspondence information that each contain information and a partial score in pair are stored, for example. Also, the credit rating information acquisition unit G236 provides the j^{th} piece of information to a calculation formula as a parameter, executes the calculation formula, and acquires a partial score, for example.

(Step S1608) The credit rating information acquisition unit G236 increments the counter j by 1. Processing returns to Step S1605.

(Step S1609) The credit rating information acquisition unit G236 acquires the i^{th} mobile partial score, using the one or more partial scores acquired in Step S1607.

(Step S1610) The counter i is incremented by 1. Processing returns to Step S1603.

(Step S1611) The credit rating information acquisition unit G236 acquires a mobile score, using the one or more mobile partial scores acquired in Step S1609, and at least temporarily accumulates it in the storage unit G21. Processing returns to higher level processing. Note that, when one mobile partial score has been acquired, the mobile partial score typically is a mobile score.

Note that, in Step S1609, the credit rating information acquisition unit G236 acquires a higher partial mobile score as each of the one or more partial scores acquired in Step S1607 increases. The credit rating information acquisition unit G236 calculates a mobile partial score in Step S1609, using an increasing function that employs the one or more partial scores acquired in Step S1607 as parameters.

Note that the credit rating information acquisition unit G236 acquires a higher mobile score as each of the one or more partial mobile scores acquired in Step S1609 increases. The credit rating information acquisition unit G236 calculates a mobile score, using an increasing function that employs the one or more partial mobile partial scores acquired in Step S1609 as parameters.

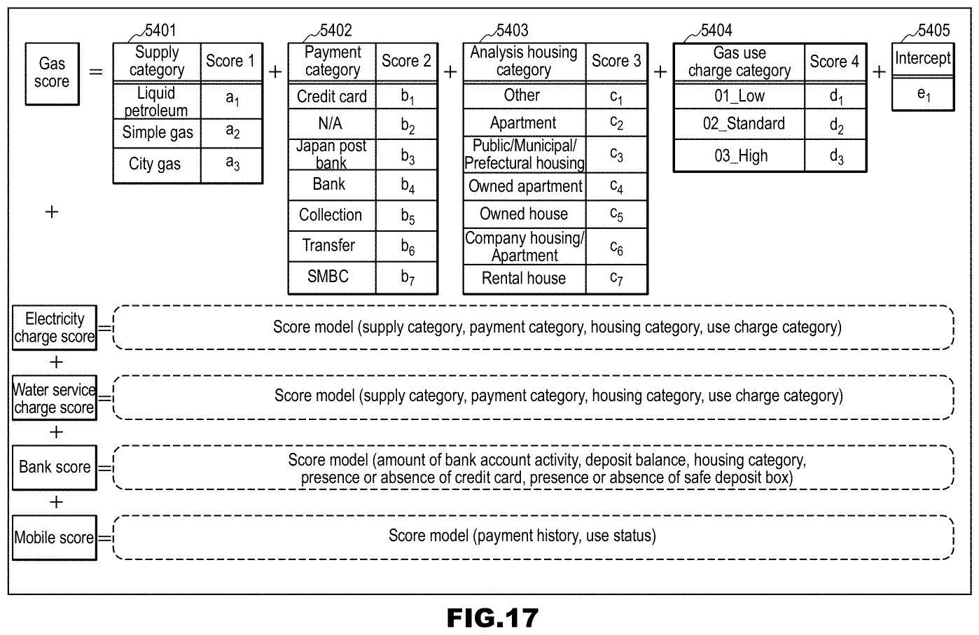

The following describes specific operations that are performed by the information system G according to the present embodiment. The conceptual diagram that shows the concept of processing that is performed by the information system G is FIG. 17.

Now, the storage unit G21 of the information processing apparatus G2 stores a score model for calculating a gas score. The storage unit G21 also stores a score model for calculating an electricity charge score. The storage unit G21 also stores a score model for calculating a water service charge score. The storage unit G21 also stores a score model for calculating a bank score. Furthermore, the storage unit G21 stores a score model for calculating a mobile score.

A score model is information that is used to acquire a score. In this example, correspondence tables that are used to acquire one or more partial scores is stored. The correspondence tables include a gas supply category correspondence table 5401, a gas payment category correspondence table 5402, a housing category information correspondence table 5403, and a gas use fee category correspondence table 5404. The score model also includes an intercept 5405.

The gas supply category correspondence table 5401 is a table that shows the correspondence between “supply category” and “score 1”. “Supply category” is gas supply category information. In the gas supply category correspondence table 5401, the partial score when gas supply category information is “liquid petroleum” is “a₁”. Note that, in FIG. 17, all partial scores are represented by signs (a₁, . . . , d₃, e₁), but they are specific numerical values when used.

The gas payment category correspondence table 5402 is a table that shows the correspondence between “payment category” and “score 2”. “Payment category” is gas payment category information.

The housing category information correspondence table 5403 is a table that shows the correspondence between “analysis housing category” and “score 3”. “Analysis housing category” is housing category information.

The gas use fee category correspondence table 5404 is a table that shows the correspondence between “gas use fee category” and “score 4”. “Gas use fee category” is gas use fee category information.

The intercept 5405 is a correction value.

In addition, although not specifically illustrated, as with the score model for the gas score, a score model for the electricity charge, a score model for the water service charge score, a score model for the bank score, and a score model for the mobile score have one or more correspondence tables for determining a partial score in correspondence with a value that has been determined.

The score model for the electricity charge score has an electricity supply category correspondence table that shows the correspondence between “electricity supply category information” and “score”, an electricity payment category correspondence table that shows the correspondence between “electricity payment category information” and “score”, a housing category information correspondence table that shows the correspondence between “housing category information” and “score”, and electricity use fee category correspondence table that shows the correspondence between “electricity use fee category information” and “score”.

The score model for the water service charge score has a water service supply category correspondence table that shows the correspondence between “water service supply category information” and “score”, a water service payment category correspondence table that shows the correspondence between “water service payment category information” and “score”, a housing category information correspondence table that shows the correspondence between “housing category information” and “score”, and water service use fee category correspondence table that shows the correspondence between “water service use fee category information” and “score”.

The score model for the bank score has a deposit and withdrawal category correspondence table that shows the correspondence between “range of the amount of bank account activity” and “score”, a bank balance category correspondence table that shows the correspondence between “range of bank deposit” and “score”, a housing category information correspondence table that shows the correspondence between “housing category information” and “score”, a credit card correspondence table that is a correspondence table regarding the score that is based on the presence or absence of a credit card, and a safe deposit box correspondence table that is a correspondence table regarding the score that is based on the presence or absence of a safe deposit box.

The score model for the mobile score has a payment history correspondence table that determines the score corresponding to payment history information, and a use status correspondence table that determines the score corresponding to use status information.

In such a situation, it is assumed that a terminal apparatus G1 accepts a credit rating acquisition instruction that contains “customer identifier=C01”. Next, the terminal processing unit G13 forms a credit rating acquisition instruction that is to be transmitted. Next, the terminal transmission unit G14 transmits the formed credit rating acquisition instruction (for example, “credit rating acquisition (C01)” to the information processing apparatus G2.

Next, the acceptance unit G221 of the information processing apparatus G2 receives a credit rating acquisition instruction (for example, “credit rating acquisition (C01)” from the terminal apparatus G1.

Next, the processing unit G23 acquires the customer identifier “C01” contained in the received credit rating acquisition instruction.

Next, the gas information acquisition unit G231 acquires gas information that is paired with the customer identifier “C01” from the gas information storage unit A212.

Also, the electricity customer information acquisition unit G232 acquires electricity customer information that is paired with the customer identifier “C01” from the electricity customer information storage unit G211.

The water service customer information acquisition unit G233 acquires water service customer information that is paired with the customer identifier “C01” from the water service customer information storage unit G212.

Also, the bank customer information acquisition unit G234 acquires one or more pieces of bank customer information that are paired with the customer identifier “C01” from the bank customer information storage unit G213.

Furthermore, the mobile customer information acquisition unit G235 acquires one or more pieces of mobile customer information that are paired with the customer identifier “C01” from the mobile customer information storage unit G214.

Thereafter, the credit rating information acquisition unit G236 references the correspondence tables 5401 to 5404 to acquire partial scores corresponding to the information contained in the gas information acquired by the gas information acquisition unit G231. Thereafter, the credit rating information acquisition unit G236 obtains a gas score by calculating the sum of the four partial scores thus acquired and the intercept “−2.93”, for example.

Similarly, the credit rating information acquisition unit G236 references the correspondence tables contained in the score model for the electricity charge to acquire four partial scores that are paired with the pieces of information contained in the electricity customer information acquired by the electricity customer information acquisition unit G232. Thereafter, the credit rating information acquisition unit G236 obtains an electricity charge score by calculating the sum of the four partial scores.

Next, the credit rating information acquisition unit G236 references the correspondence tables contained in the score model for the water service charge score to acquire four partial scores that are paired with the pieces of information contained in the water service customer information acquired by the water service customer information acquisition unit G233. Thereafter, the credit rating information acquisition unit G236 obtains a water service charge score by calculating the sum of the four partial scores.

Next, the credit rating information acquisition unit G236 references the correspondence tables contained in the score model for the bank score to acquire five partial scores that are paired with the pieces of information contained in the bank customer information acquired by the bank customer information acquisition unit G234. Thereafter, the credit rating information acquisition unit G236 obtains a bank score for one family by calculating the sum of the five partial scores. Thereafter, the credit rating information acquisition unit G236 acquires bank scores for the family members of the household by performing the same processing on the family members of the household. Thereafter, the credit rating information acquisition unit G236 obtains a bank score of the household, using the bank scores of the family members.

Next, the credit rating information acquisition unit G236 references the correspondence tables contained in the score model for the mobile score to acquire five partial scores that are paired with the pieces of information contained in the mobile customer information acquired by the mobile customer information acquisition unit G235. Thereafter, the credit rating information acquisition unit G236 obtains a mobile score for one family by calculating the sum of the two partial scores. Thereafter, the credit rating information acquisition unit G236 acquires mobile scores of the family members of the household by performing the same processing on the family members of the household. Thereafter, the credit rating information acquisition unit G236 obtains a mobile score of the household, using the mobile scores of the family members.

Next, the credit rating information acquisition unit G236 substitutes the acquired gas score, electricity charge score, water service charge score, bank score, and mobile score into the calculation formula as parameters, and executes the calculation (executes a sum operation here) to acquire credit rating information.

Next, the credit rating information output unit G241 transmits the acquired credit rating information to the terminal apparatus G1 in association with the customer identifier “C01”.

Next, the terminal reception unit G15 of the terminal apparatus G1 receives credit rating information corresponding to the credit rating acquisition instruction. Thereafter, the terminal processing unit G13 forms information that is to be output, using the credit rating information thus received. Next, the terminal output unit G16 outputs credit rating information regarding the household indicated by the customer identifier “C01”.

As described above, according to the present embodiment, it is possible to acquire a credit rating of the household, using information regarding the use of gas.

In addition, according to the present embodiment, it is possible to acquire a credit rating of the household, using one or more pieces of information of: information regarding the use of gas; information regarding the use of electricity; information regarding the use of water service; information regarding a bank account; and information regarding the use of a mobile.

Note that the processing in the present embodiment may be realized using software. This software may be distributed through software downloading or the like. Also, this software may be recorded on a recording medium such as a CD-ROM and distributed. Note that the same applies to the other embodiments in the present description. The software that realizes the information processing apparatus G2 in the present embodiment is the program described below. That is to say, this program is a program that enables a computer to function as: an acceptance unit that accepts a customer identifier that identifies a customer; a gas information acquisition unit that acquires gas information that contains gas use information regarding use of gas, and that is associated with the same customer identifier as the customer identifier accepted by the acceptance unit; a credit rating information acquisition unit that acquires credit rating information that specifies a credit rating of a household that is identified by the customer identifier accepted by the acceptance unit, using the gas information acquired by the gas information acquisition unit; and a credit rating information output unit that outputs the credit rating information acquired by the credit rating information acquisition unit.

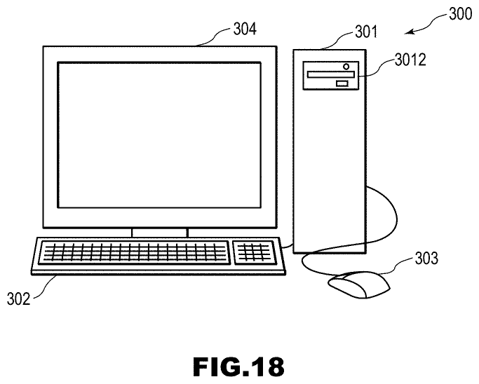

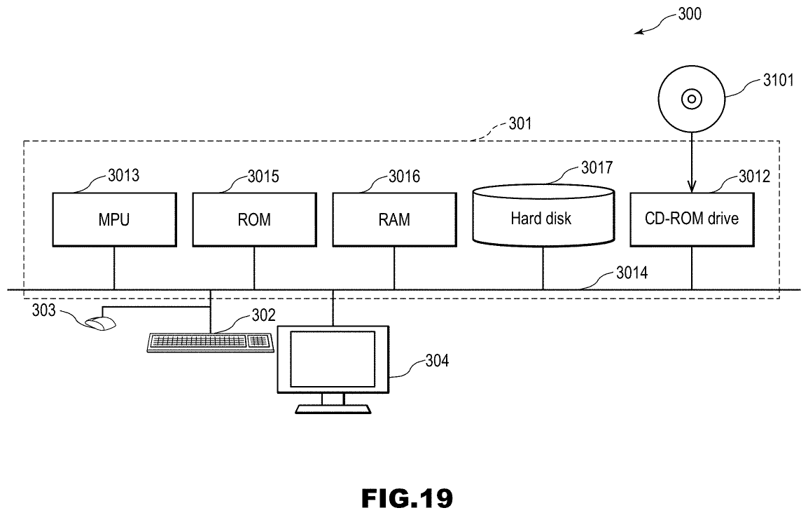

FIG. 18 shows an external appearance of a computer that realizes the information processing apparatus B2 and so on according to the various embodiments described above by executing the programs described in the present description. The above-described embodiments can be realized using computer hardware and a computer program that is executed thereon. FIG. 18 is an overview diagram for this computer system 300, and FIG. 19 is a block diagram for the system 300.

In FIG. 18, the computer system 300 includes a computer 301 that includes a CD-ROM drive, a keyboard 302, a mouse 303, and a monitor 304.

In FIG. 19, the computer 301 includes, in addition to a CD-ROM drive 3012, an MPU 3013, a bus 3014 that is connected to the CD-ROM drive 3012 and so on, a ROM 3015 for storing programs such as a bootup program, a RAM 3016 that is connected to the MPU 3013 to temporarily store an instruction from an application program, and provide a temporary memory space, and a hard disk 3017 for storing an application program, a system program, and data. Although not illustrated here, the computer 301 may further include a network card that provides connection to a LAN.

The program that causes the computer system 300 to execute the functions of the information processing apparatus B2 and so on according to the above-described embodiments may be stored in a CD-ROM 3101, inserted into the CD-ROM drive 3012, and further transferred to the hard disk 3017. Instead, the program may be transmitted to the computer 301 via a network (not shown), and stored in the hard disk 3017. The program is loaded to the RAM 3016 when it is to be executed. The program may be loaded directly from the CD-ROM 3101 or a network.

The program does not necessarily include an operating system (OS) that causes the computer 301 to execute functions such as the information processing apparatus B2 according to the above-described embodiments, a third-party program, or the like. The program need only include an instruction part that calls an appropriate function (module) in a controlled manner to obtain the desired result. It is well known how the computer system 300 works, and therefore detailed description thereof will be omitted.

A single computer or a plurality of computers may execute the above-described program. That is to say, centralized processing or distributed processing may be performed.

Also, as a matter of course, in each of the above-described embodiments, the two or more communication means that exist in one apparatus may be physically realized using one medium.

Furthermore, in each of the above-described embodiments, each kind of processing may be realized through centralized processing that is performed by a single apparatus, or may be realized through distributed processing that is performed by a plurality of apparatuses.

The present invention is not limited to the above-described embodiments, and various modifications can be made. Such modifications are also included in the scope of the present invention as a matter of course.

### INDUSTRIAL APPLICABILITY

As described above, the information processing apparatus according to the present invention achieves the effect of acquiring a credit rating of a household, and is useful as, for example a server apparatus that performs processing related to credit.

1. An information processing apparatus comprising:
an acceptance unit that accepts a customer identifier that identifies a customer;
a gas information acquisition unit that acquires gas information that contains gas use information regarding use of gas, and that is associated with the same customer identifier as the customer identifier accepted by the acceptance unit;
a credit rating information acquisition unit that acquires credit rating information that specifies a credit rating of a household that is identified by the customer identifier accepted by the acceptance unit, using the gas information acquired by the gas information acquisition unit; and
a credit rating information output unit that outputs the credit rating information acquired by the credit rating information acquisition unit.

2. The information processing apparatus according to claim 1,
wherein the gas use information contains gas use fee category information that specifies how high a gas use fee is, and
the gas information contains, in addition to the gas use fee category information, one or more pieces of information of: gas supply category information that specifies a type of gas that is supplied; gas payment category information that specifies a payment means for a gas fee; and housing category information that specifies a type of a residence of a customer.

3. The information processing apparatus according to claim 1, further comprising
an electricity customer information acquisition unit that acquires electricity customer information regarding use of electricity, associated with the same customer identifier as the customer identifier accepted by the acceptance unit,
wherein the credit rating information acquisition unit acquires credit rating information, using the electricity customer information as well.

4. The information processing apparatus according to claim 3,
wherein the electricity customer information contains one or more pieces of information of: electricity supply category information that specifies a type of electricity supplied; electricity payment category information that specifies a means for payment of an electricity fee; housing category information that specifies a type of a residence of a customer; and electricity use fee category information that specifies how high an electricity use fee is.

5. The information processing apparatus according to claim 1, further comprising
a water service customer information acquisition unit that acquires water service customer information regarding use of water service, associated with the same customer identifier as the customer identifier accepted by the acceptance unit,
wherein the credit rating information acquisition unit acquires credit rating information, using the water service customer information as well.

6. The information processing apparatus according to claim 5,
wherein the water service customer information contains one or more pieces of information of: water service supply category information that specifies a type of water service supplied; water service payment category information that specifies a means for payment of water service fee; housing category information that specifies a type of a residence of a customer; and water service use fee category information that specifies how high a water service use fee is.

7. The information processing apparatus according to claim 1, further comprising
a bank customer information acquisition unit that acquires bank customer information regarding a bank account, associated with a personal identifier that is paired with the same customer identifier as the customer identifier accepted by the acceptance unit,
wherein the credit rating information acquisition unit acquires credit rating information, using the bank customer information as well.

8. The information processing apparatus according to claim 7,
wherein the bank customer information acquisition unit acquires two or more pieces of bank customer information that are associated with two or more personal identifiers that are paired with the same customer identifier as the customer identifier accepted by the acceptance unit, and
the credit rating information acquisition unit acquires credit rating information, using the two or more pieces of bank customer information as well.

9. The information processing apparatus according to claim 7,
wherein the bank customer information contains one or more pieces of information of: an amount of bank account activity; a deposit balance; a housing category information that specifies a type of a residence of a customer; presence or absence of a credit card; and presence or absence of a safe deposit box.

10. The information processing apparatus according to claim 1, further comprising
a mobile customer information acquisition unit that acquires mobile customer information regarding use of a mobile, associated with a personal identifier that is paired with the same customer identifier as the customer identifier accepted by the acceptance unit,
wherein the credit rating information acquisition unit acquires credit rating information, using the mobile customer information as well.

11. The information processing apparatus according to claim 10,
wherein the mobile customer information acquisition unit acquires two or more pieces of mobile customer information that are associated with two or more personal identifiers that are paired with the same customer identifier as the customer identifier accepted by the acceptance unit, and
the credit rating information acquisition unit acquires credit rating information, using the two or more pieces of mobile customer information as well.

12. The information processing apparatus according to claim 10,
wherein the mobile customer information contains one or more pieces of information of: a mobile bill payment history; and a mobile use status.

13. The information processing apparatus according to claim 1, further comprising:
a gas information storage unit that stores two or more pieces of gas information that contain gas use information, in association with a customer identifier;
a gas information reception unit that receives gas information that is associated with a cylinder identifier, from a gas information transmission apparatus that includes a terminal acquisition unit that acquires gas information that is information that contains gas use information regarding use of gas in an LPG cylinder and corresponds to a cylinder identifier that identifies the LPG cylinder, and a terminal transmission unit that transmits the gas information acquired by the terminal acquisition unit to the information processing apparatus; and
a gas information accumulation unit that accumulates the gas information received by the gas information reception unit, in the gas information storage unit, in association with time information and the cylinder identifier,
wherein the gas information acquisition unit acquires gas information that contains gas use information that is contained in two or more pieces of gas information that are associated with the same customer identifier as the customer identifier accepted by the acceptance unit.

14. An information processing method that is realized using an acceptance unit, a gas information acquisition unit, a credit rating information acquisition unit, and a credit rating information output unit, the information processing method comprising:
an acceptance step in which the acceptance unit accepts a customer identifier that identifies a customer;
a gas information acquisition step in which the gas information acquisition unit acquires gas information that contains gas use information regarding use of gas, and that is associated with the same customer identifier as the customer identifier accepted in the acceptance step;
a credit rating information acquisition step in which the credit rating information acquisition unit acquires credit rating information that specifies a credit rating of a household that is identified by the customer identifier accepted in the acceptance step, using the gas information acquired in the gas information acquisition step; and
a credit rating information output step in which the credit rating information output unit outputs the credit rating information acquired in the credit rating information acquisition step.

15. A non-transitory computer readable medium storing a program for enabling a computer to function as:
an acceptance unit that accepts a customer identifier that identifies a customer;
a gas information acquisition unit that acquires gas information that contains gas use information regarding use of gas, and that is associated with the same customer identifier as the customer identifier accepted by the acceptance unit;
a credit rating information acquisition unit that acquires credit rating information that specifies a credit rating of a household that is identified by the customer identifier accepted by the acceptance unit, using the gas information acquired by the gas information acquisition unit; and
a credit rating information output unit that outputs the credit rating information acquired by the credit rating information acquisition unit.
